(19) United States
(12) Patent Application Publication
(10) Pub. No.: US 2026/0363926 A1
(43) Pub. Date: Nov. 19, 2026

(54) Patient Transport Apparatus With Handle Assembly Including A Damper

(71) Applicant: Stryker Corporation, Portage, MI (US)

(72) Inventors: Michael T. Brubaker, Portage, MI (US); Brian J. Tessmer, Mattawan, MI (US); Sean Derrick, Kalamazoo, MI (US); James Robert Tumavich, JR., Kalamazoo, MI (US)

(73) Assignee: Stryker Corporation, Portage, MI (US)

(21) Appl. No.: 19/121,906

(22) PCT Filed: Oct. 18, 2023
(86) PCT No.: PCT/US2023/035382

§ 371 Date: Apr. 17, 2025

Related U.S. Application Data
(60) Provisional application No. 63/417,077, filed on Oct. 18, 2022.

(51) Int. Cl. A61G 5/06; A61G 5/04; A61G 5/08

(52) U.S. Cl. CPC A61G 5/061; A61G 5/04; A61G 5/066; A61G 5/0841; A61G 5/0891

(57) ABSTRACT

A patient transport apparatus for transporting a patient along stairs. The patient transport apparatus includes a support structure including a rear support assembly having a rear upright defining a support channel. The patient transport apparatus also includes a handle assembly. The handle assembly includes an upper grip, and an extension post supporting the upper grip and disposed in the support channel to guide movement of the handle assembly between: an extended position where the upper grip is spaced from the user interface, and a collapsed position where the upper grip is disposed adjacent to the user interface. Additionally, the patient transport apparatus includes a damper interposed between the support channel and the extension post to control movement of the extension post as the handle assembly moves from the extended position to the collapsed position.

### CROSS-REFERENCE TO RELATED APPLICATION(S)

The subject patent application claims priority to and all the benefits of United States Provisional Patent Application No. 63/417,077, filed on Oct. 18, 2022, the disclosure of which is hereby incorporated by reference in its entirety.

### BACKGROUND

In various environments, persons with limited mobility may have difficulty traversing stairs without assistance. In certain emergency situations, traversing stairs may be the only viable option for exiting a building. Here, in order for a caregiver to transport a patient along stairs in a safe and controlled manner, a stair chair or evacuation chair may be utilized to facilitate safe stair traversal. Stair chairs are adapted to transport seated patients either up or down flights of stairs, with two caregivers typically supporting, stabilizing, or otherwise carrying the stair chair with the patient supported thereon.

Certain types of conventional stair chairs include collapsible handle assemblies configured to be engaged by a user to help transport patients either up or down flights of stairs. However, depending on the specific configuration of the stair chair, conventional collapsible handle assemblies can sometimes travel within an area that may be occupied by a portion of the patient's body and/or the caregiver's hands.

A patient transport apparatus designed to overcome one or more of the aforementioned challenges is desired.

### SUMMARY

The present disclosure includes a patient transport apparatus operable by a user for transporting a patient along stairs. The patient transport apparatus includes a support structure including a rear support assembly having a rear upright defining a support channel. The patient transport apparatus also includes a seat section and a back section coupled to the support structure for supporting the patient, a track assembly extending from the support structure and having a belt for traversing stairs, and a motor coupled to the track assembly to selectively generate torque to drive the belt. The patient transport apparatus further includes a user interface disposed on the rear support assembly and arranged for engagement by a user and including an activation input control for operating the motor to drive the belt. The patient transport apparatus also further includes a handle assembly. The handle assembly includes an upper grip, and an extension post supporting the upper grip and disposed in the support channel to guide movement of the handle assembly between: an extended position where the upper grip is spaced from the user interface, and a collapsed position where the upper grip is disposed adjacent to the user interface. Additionally, the patient transport apparatus includes a damper interposed between the support channel and the extension post to control movement of the extension post as the handle assembly moves from the extended position to the collapsed position.

### BRIEF DESCRIPTION OF THE DRAWINGS

Other advantages of the present invention will be readily appreciated as the same becomes better understood by reference to the following detailed description when considered in connection with the accompanying drawings.

FIG. 1 is a front perspective view of a patient transport apparatus according to the present disclosure, shown arranged in a chair configuration for supporting a patient for transport along a floor surface, and shown having a track assembly disposed in a retracted position, and a handle assembly disposed in a collapsed position.

FIG. 2 is another front perspective view of the patient transport apparatus of FIG. 1, shown arranged in a stair configuration for supporting the patient for transport along stairs, and shown with the track assembly disposed in a deployed position, and with the handle assembly disposed in an extended position.

FIG. 3 is a rear perspective view of the patient transport apparatus of FIGS. 1-2, shown arranged in the stair configuration as depicted in FIG. 2, and shown having an extension lock mechanism, a folding lock mechanism, and a deployment lock mechanism.

FIG. 4 is a partial schematic view of a control system of the patient transport apparatus of FIGS. 1-3, shown with a controller disposed in communication with a battery, a user interface, and a drive system.

FIG. 5 is a right-side plan view of the patient transport apparatus of FIGS. 1-4, shown arranged in a stowed configuration maintained by the folding lock mechanism.

FIG. 6A is another right-side plan view of the patient transport apparatus arranged in the chair configuration and with a handle assembly in a collapsed position.

FIG. 6B is another right-side plan view of the patient transport apparatus arranged in the chair configuration and with the handle assembly in an intermediate position.

FIG. 6C is another right-side plan view of the patient transport apparatus arranged in the chair configuration and with the handle assembly in an extended position.

FIG. 7A is a partial rear perspective view of the patient transport apparatus of FIGS. 1-6B, shown arranged in the chair configuration as depicted in FIG. 1, with the deployment lock mechanism shown retaining the track assembly in the retracted position.

FIG. 7B is another partial rear perspective view of the patient transport apparatus of FIG. 7A, shown arranged in the stair configuration as depicted in FIGS. 2-3, with the deployment lock mechanism shown retaining the track assembly in the deployed position.

FIG. 8 is a rear view of the back side of the patient transport apparatus of FIG. 1 depicting the user interface.

FIG. 9A is a right-side plan view of the patient transport apparatus of FIG. 1, shown supporting a patient in the chair configuration on a floor surface adjacent to stairs, and shown with a first caregiver engaging a pivoting handle assembly.

FIG. 9B is another right-side plan view of the patient transport apparatus of FIG. 9A, shown with the first caregiver having engaged the deployment lock mechanism to move the track assembly out of the retracted position and a second caregiver engaging a front handle assembly in an extended position.

FIG. 9C is another right-side plan view of the patient transport apparatus of FIG. 9B, shown having moved towards the stairs for descent while supported by the first and second caregivers.

FIG. 9D is another right-side plan view of the patient transport apparatus of FIG. 9C, shown having moved initially down the stairs for descent to bring a belt of the track assembly into contact with the stairs while still supported by the first and second caregivers.

FIG. 9E is another right-side plan view of the patient transport apparatus of FIG. 9D, shown with the belt of the track assembly in contact with the stairs while still supported by the first and second caregivers.

FIG. 9F is another right-side plan view of the patient transport apparatus of FIG. 9D, shown with the belt of the track assembly in contact with the stairs while still supported by the first and second caregivers and with first.

FIG. 10 is a top perspective view of the handle assembly spaced from a first and second rear upright of the patient transport apparatus.

FIG. 11A is a front view of the handle assembly engaged with the first and second rear upright of the patient transport apparatus.

FIG. 11B is a cross-sectional view of FIG. 11A showing one example of a damper.

FIG. 11C is a cross-sectional view of FIG. 11A showing another example of a damper.

FIG. 12A is a bottom perspective view of an extension post including a collar and a damper including one version of a deflectable member.

FIG. 12B is a cross-sectional representation of the extension post of FIG. 12A.

FIG. 12C is a cross-sectional view of FIG. 11A showing the damper configuration of FIG. 12A engaged with a rear upright of the patient transport apparatus.

FIG. 13A is a bottom perspective view of an extension post including a collar and a damper including another version of a deflectable member.

FIG. 13B is a cross-sectional representation of the extension post of FIG. 13A.

FIG. 14A is a bottom perspective view of an extension post including a collar and a damper including yet another version of a deflectable member.

FIG. 14B is a cross-sectional representation of the extension post of FIG. 14A.

FIG. 15A is a cross-sectional view of FIG. 11A showing yet another configuration of the damper engaged with a rear upright of the patient transport apparatus.

FIG. 15B is a cross-sectional view of FIG. 11A showing still another configuration of the damper engaged with a rear upright of the patient transport apparatus.

FIG. 16A is a perspective view of a configuration of the handle assembly and the rear uprights including a plurality of detents.

FIG. 16B is an enlarged detail view of FIG. 16A.

FIG. 17 is a cross-sectional view of the patient transport apparatus showing a detent mechanism engaging one of the plurality of detents of FIG. 16A.

FIG. 18 is a perspective view of a configuration of the handle assembly and the rear uprights including dampers coupled to each of the rear uprights.

FIG. 19 is a cross-sectional view of the patient transport apparatus showing one of the dampers and the rear uprights of FIG. 18.

### DETAILED DESCRIPTION

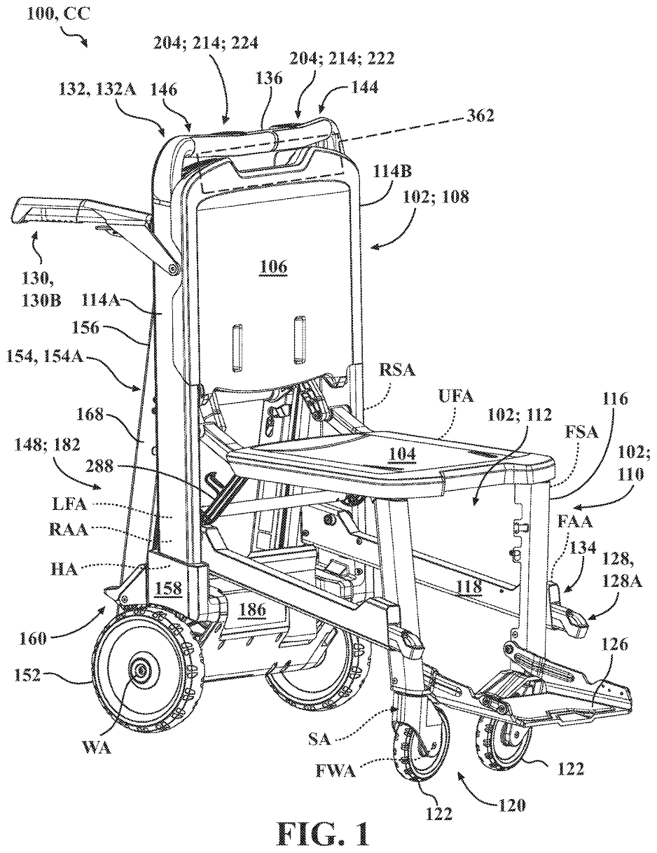

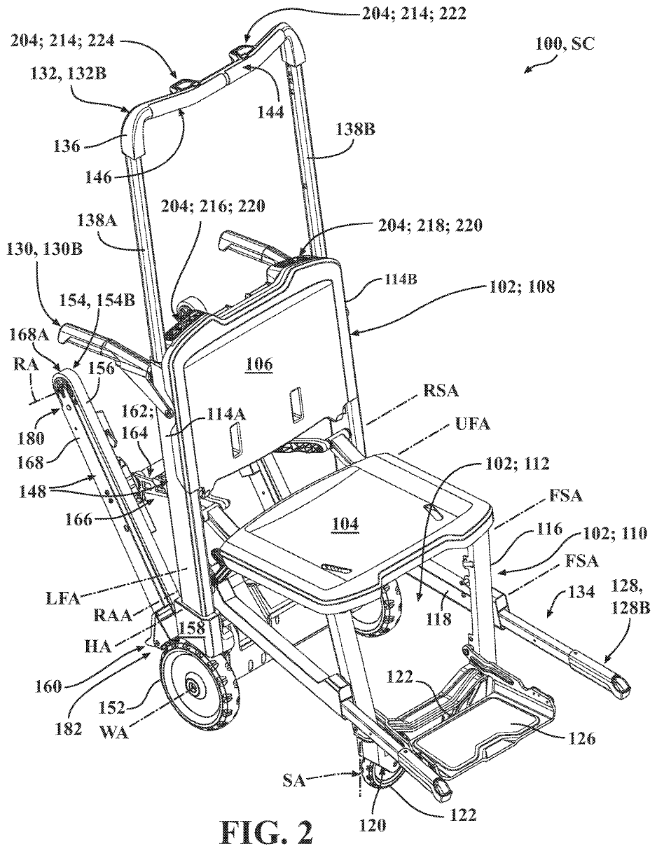

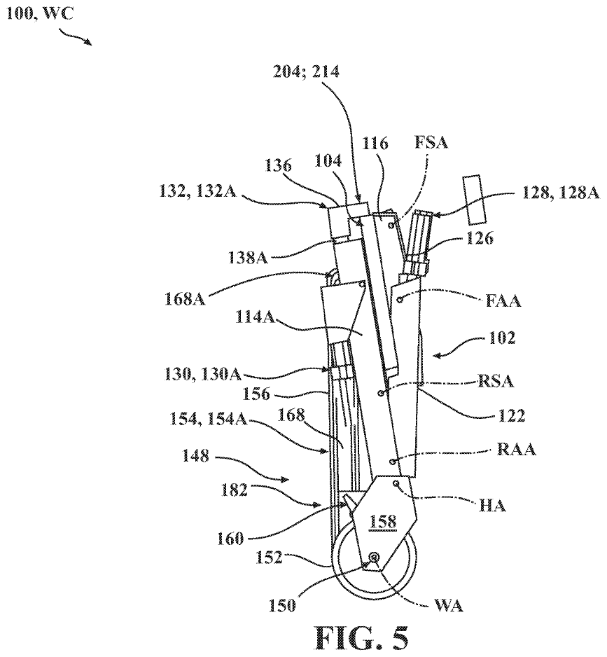

Referring now to the drawings, wherein like numerals indicate like parts throughout the several views, the present disclosure is generally directed toward a patient transport apparatus 100 configured to allow one or more caregivers to transport a patient. To this end, the patient transport apparatus 100 is realized as a “stair chair” which can be operated in a chair configuration CC (see FIG. 1) to transport the patient across ground or floor surfaces FS (e.g., pavement, hallways, and the like), as well as in a stair configuration SC (see FIG. 2) to transport the patient along stairs ST. As will be appreciated from the subsequent description below, the patient transport apparatus 100 of the present disclosure is also configured to be operable in a stowed configuration WC (see FIG. 5) when not being utilized to transport patients (e.g., for storage in an ambulance).

As is best shown in FIG. 1, the patient transport apparatus 100 comprises a support structure 102 to which a seat section 104 and a back section 106 are operatively attached. The seat section 104 and the back section 106 are each shaped and arranged to provide support to the patient during transport. The support structure 102 generally includes a rear support assembly 108, a front support assembly 110, and an intermediate support assembly 112. The back section 106 is coupled to the rear support assembly 108 for concurrent movement. To this end, the rear support assembly 108 comprises a first rear upright 114A arranged on a first side of the rear support assembly 108. The rear support assembly 108 may further comprise a second read upright 114B on a second side of the rear support assembly 108, opposite the first side. The rear uprights 114A, 114B may extend generally vertically and are secured to the back section 106 such as with fasteners (not shown in detail).

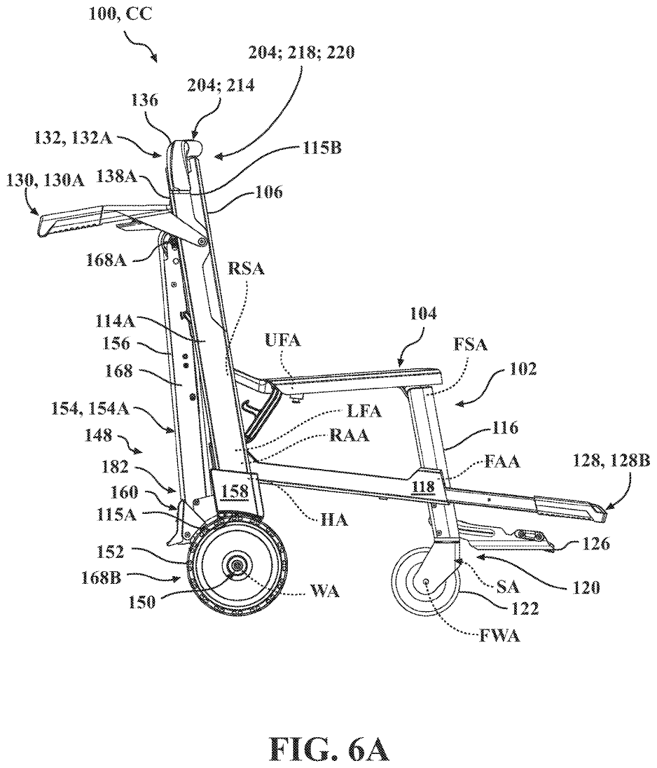

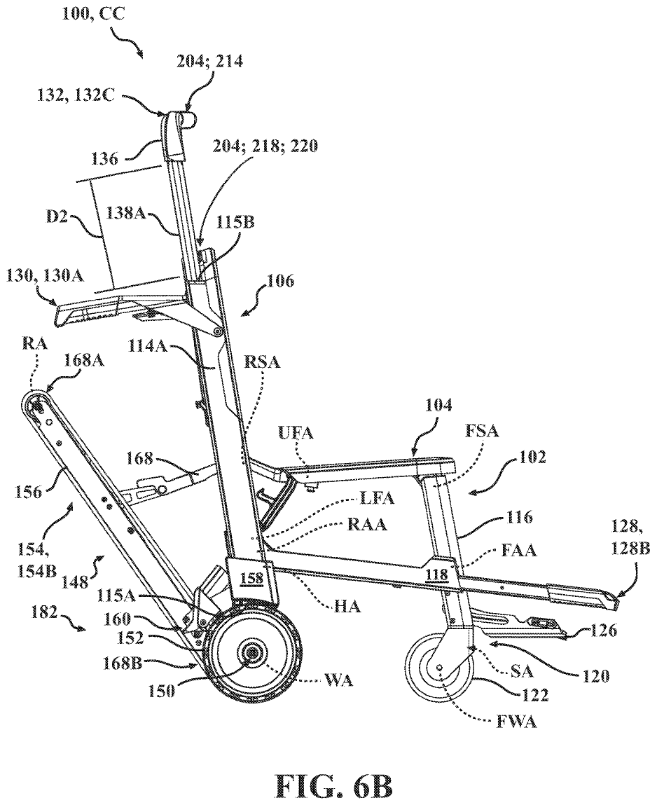

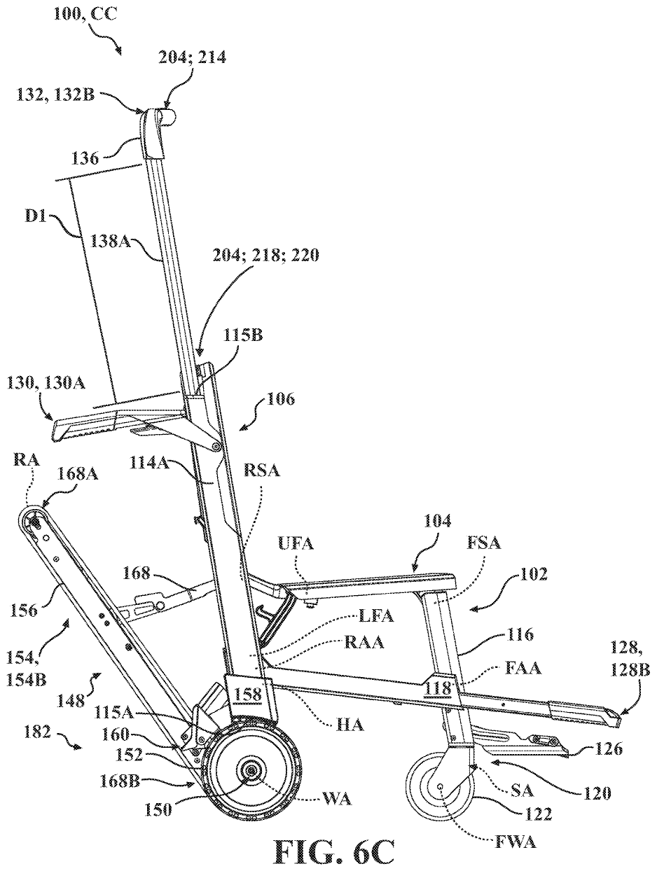

The intermediate support assembly 112 and the seat section 104 are each pivotably coupled to the rear support assembly 108. More specifically, the seat section 104 is arranged so as to pivot about a rear seat axis RSA which extends through the rear uprights 114A, 114B (compare FIGS. 5-6A; pivoting about rear seat axis RSA not shown in detail), and the intermediate arms 118 of the intermediate support assembly 112 are arranged so as to pivot about a rear arm axis RAA which is spaced from the rear seat axis RSA and also extends through the rear uprights 114A, 114B (compare FIGS. 5-6A; pivoting about rear arm axis RAA not shown in detail). Furthermore, the intermediate support assembly 112 and the seat section 104 are also each pivotably coupled to the front support assembly 110. Here, the seat section 104 pivots about a front seat axis FSA which extends through the front struts 116 (compare FIGS. 5-6A; pivoting about front seat axis FSA not shown in detail), and the intermediate arms 118 pivot about a front arm axis FAA which is spaced from the front seat axis FSA and extends through the front struts 116 (compare FIGS. 5-6A; pivoting about front arm axis FAA not shown in detail). The intermediate support assembly 112 is disposed generally vertically below the seat section 104 such that the rear support assembly 108, the front support assembly 110, the intermediate support assembly 112, and the seat section 104 generally define a four-bar linkage which helps facilitate movement between the stowed configuration WC (see FIG. 5) and the chair configuration CC (see FIG. 6A). While the seat section 104 is generally configured to remain stationary relative to the support structure 102 when operating in the chair configuration CC or in the stair configuration CC according to the illustrated versions, it is contemplated that the seat section 104 could comprise multiple components which cooperate to facilitate “sliding” movement relative to the seat section 104 under certain operating conditions, such as to position the patient's center of gravity advantageously for transport. Other configurations are contemplated.

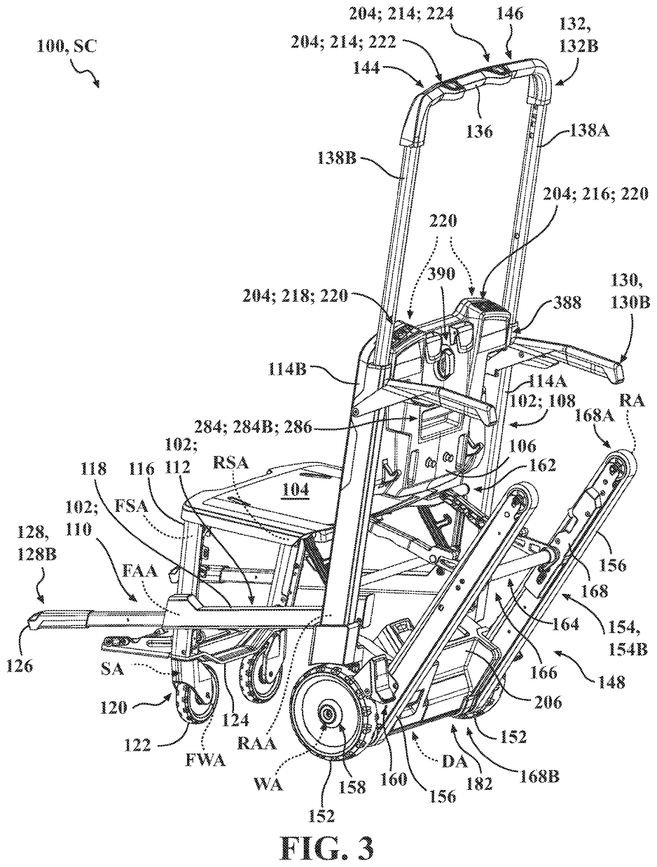

Referring now to FIGS. 1-3, the front support assembly 110 includes a pair of caster assemblies 120 which each comprise a front wheel 122 arranged to rotate about a respective front wheel axis FWA and to pivot about a respective swivel axis SA (compare FIGS. 5-6A; pivoting about swivel axis SA not shown in detail). The caster assemblies 120 are generally arranged on opposing lateral sides of the front support assembly 110 and are operatively attached to the front struts 116. A lateral brace 124 (see FIG. 3) extends laterally between the front struts 116 to, among other things, afford rigidity to the support structure 102. Here, a foot rest 126 is pivotably coupled to each of the front struts 116 adjacent to the caster assemblies 120 (pivoting not shown in detail) to provide support to the patient's feet during transport. For each of the pivotable connections disclosed herein, it will be appreciated that one or more fasteners, bushings, bearings, washers, spacers, and the like may be provided to facilitate smooth pivoting motion between various components.

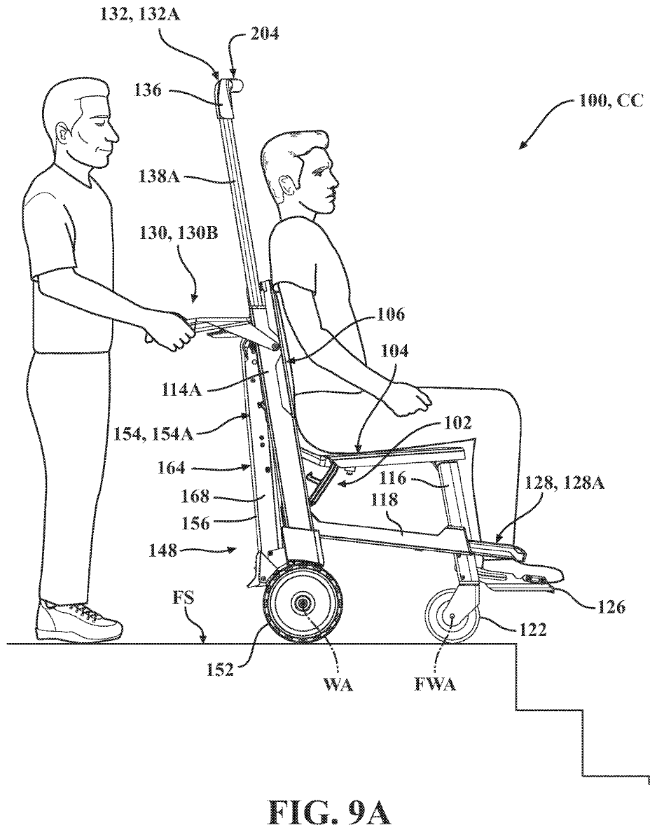

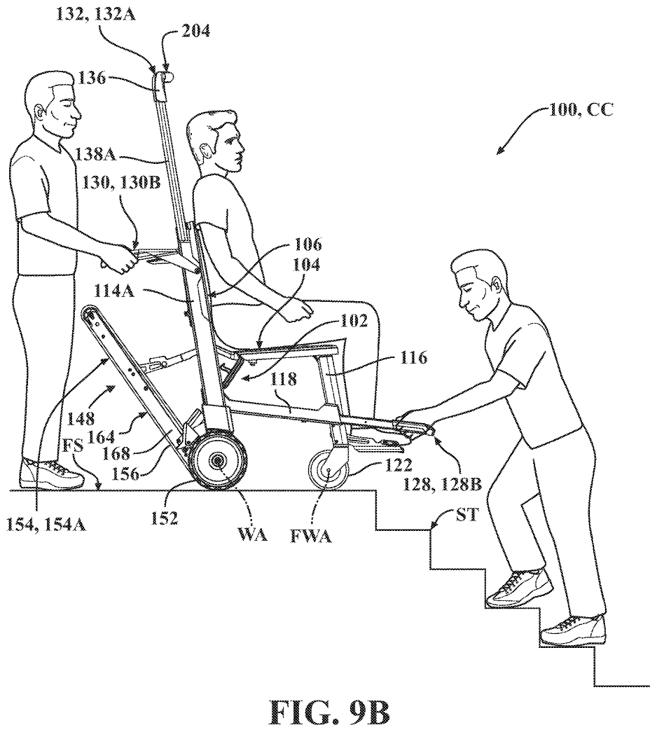

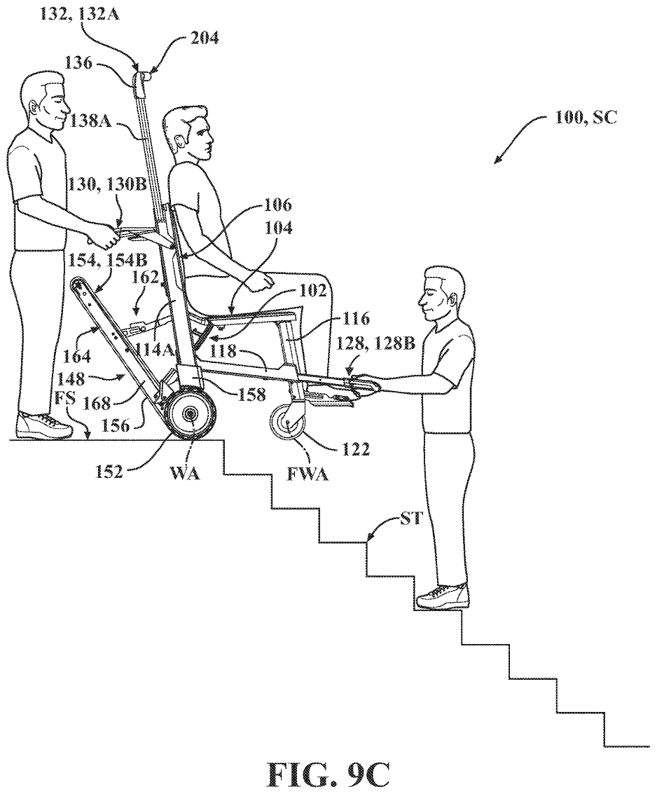

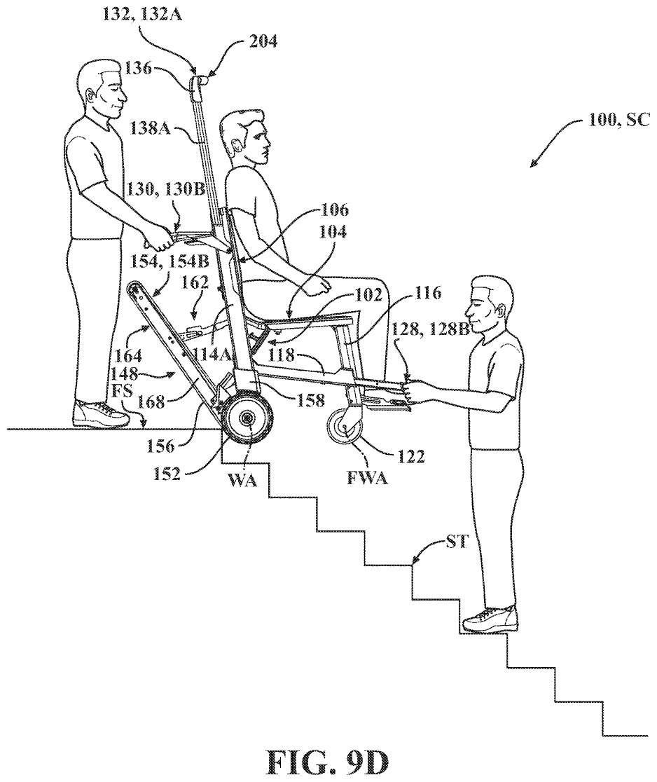

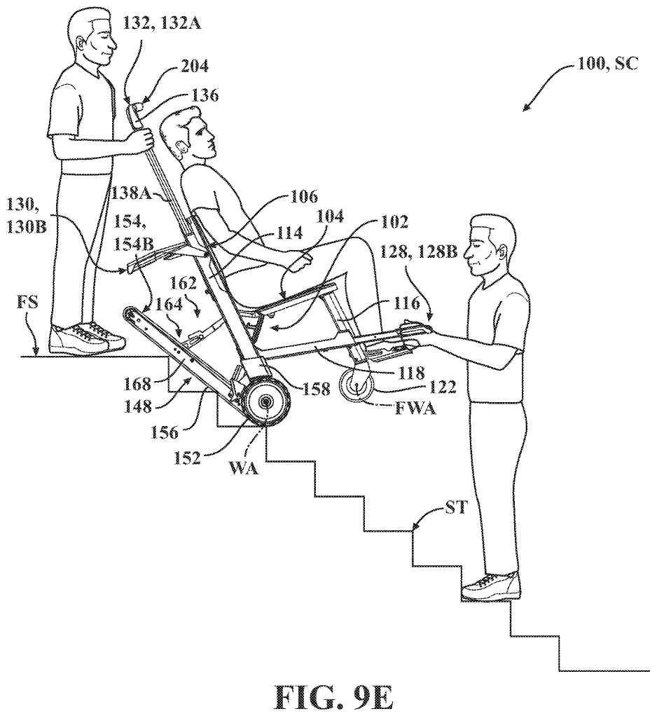

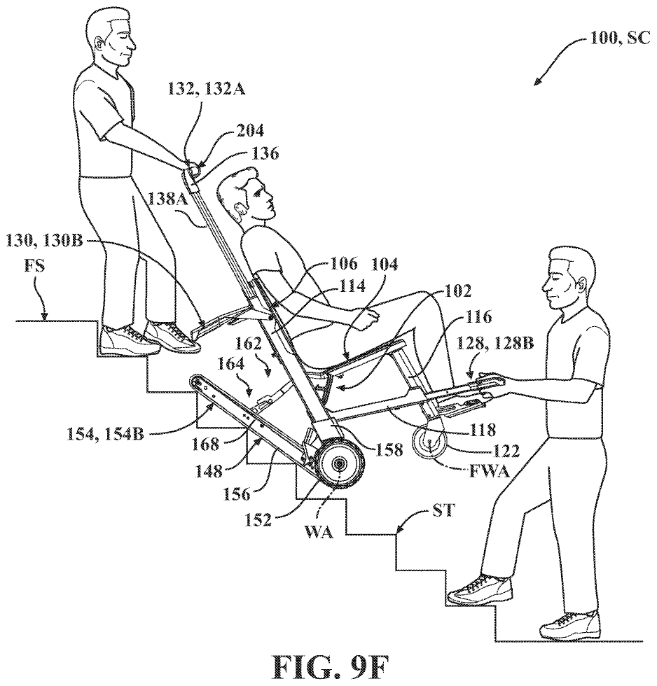

The representative versions of the patient transport apparatus 100 illustrated throughout the drawings comprise different handles arranged for engagement by caregivers during patient transport. More specifically, the patient transport apparatus 100 comprises front handle assemblies 128, pivoting handle assemblies 130, and an upper handle assembly 132 (hereinafter referred to as “handle assembly 132”), each of which will be described in greater detail below. The front handle assemblies 128 are supported within the respective intermediate arms 118 for movement between a collapsed position 128A (see FIG. 9A) and an extended position 128B (see FIG. 9B). To this end, the front handle assemblies 128 may be slidably supported by bushings, bearings, and the like (not shown) coupled to the intermediate arms 118, and may be lockable in and/or between the collapsed position 128A and the extended position 128B via respective front handle locks 134 (see FIG. 1).

Here, a caregiver may engage the front handle locks 134 (not shown in detail) to facilitate moving the front handle assemblies 128 between the collapsed position 128A and the extended position 128B. The front handle assemblies 128 are generally arranged so as to be engaged by a caregiver during patient transport up or down stairs ST when in the extended position 128B. It will be appreciated that the front handle assemblies 128 could be of various types, styles, and/or configurations suitable to be engaged by caregivers to support the patient transport apparatus 100 for movement. While the illustrated front handle assemblies 128 are arranged for telescoping movement, other configurations are contemplated. By way of non-limiting example, the front handle assemblies 128 could be pivotably coupled to the support structure 102 or other parts of the patient transport apparatus 100. In some versions, the front handle assemblies 128 could be configured similar to as is disclosed in U.S. Pat. No. 6,648,343, the disclosure of which is hereby incorporated by reference in its entirety.

The pivoting handle assemblies 130 are coupled to the respective rear uprights 114A, 114B of the rear support assembly 108, and are movable relative to the rear uprights 114A, 114B between a stowed position 130A and an engagement position 130B. Like the front handle assemblies 128, the pivoting handle assemblies 130 are generally arranged for engagement by a caregiver during patient transport, and may advantageously be utilized in the engagement position 130B when the patient transport apparatus 100 operates in the chair configuration CC to transport the patient along floor surfaces FS. In some versions, the pivoting handle assemblies 130 could be configured similar to as is disclosed in U.S. Pat. No. 6,648,343, previously incorporated by reference. Other configurations are contemplated.

As noted above, the patient transport apparatus 100 is configured for use in transporting the patient across floor surfaces FS, such as when operating in the stair configuration SC, and for transporting the patient along stairs ST when operating in the stair configuration SC. To these ends, the illustrated patient transport apparatus 100 includes a carrier assembly 148 arranged for movement relative to the support structure 102 between the chair configuration CC and the stair configuration ST. The carrier assembly 148 generally comprises at least one shaft 150 defining a wheel axis WA, one or more rear wheels 152 supported for rotation about the wheel axis WA, at least one track assembly 154 having a belt 156 for engaging stairs ST, and one or more hubs 158 supporting the shaft 150 and the track assembly 154 and the shaft 150 for concurrent pivoting movement about a hub axis HA. Here, movement of the carrier assembly 148 from the chair configuration CC (see FIG. 1) to the stair configuration SC (see FIGS. 2 and 6B) simultaneously deploys the track assembly 154 for engaging stairs ST with the belt 156 and moves the wheel axis WA longitudinally closer to the front support assembly 110 so as to position the rear wheels 152 further underneath the seat section 104 and closer to the front wheels 122.

As is described in greater detail below in connection with FIGS. 9A-9F, the movement of the rear wheels 152 relative to the front wheels 122 when transitioning from the chair configuration CC to the stair configuration SC that is afforded by the patient transport apparatus 100 of the present disclosure affords significant improvements in patient comfort and caregiver usability, in that the rear wheels 152 are arranged to promote stable transport across floor surfaces FS in the chair configuration CC but are arranged to promote easy transitioning from floor surfaces to stairs ST as the patient transport apparatus 100 is “tilted” backwards about the rear wheels 152 (compare FIGS. 9D-9F). Put differently, positioning the rear wheels 152 relative to the front wheels 122 consistent with the present disclosure makes “tilting” the patient transport apparatus 100 significantly less burdensome for the caregivers and, at the same time, much more comfortable for the patient due to the arrangement of the patient's center of gravity relative to the portion of the rear wheels 152 contacting the floor surface FS as the patient transport apparatus 100 is “tilted” backwards to transition into engagement with the stairs ST.

In the representative versions illustrated herein, the carrier assembly 148 comprises hubs 158 that are pivotably coupled to the respective rear uprights 114A, 114B for concurrent movement about the hub axis HA. Here, one or more bearings, bushings, shafts, fasteners, and the like (not shown in detail) may be provided to facilitate pivoting motion of the hubs 158 relative to the rear uprights 114A, 114B. Similarly, bearings and/or bushings (not shown) may be provided to facilitate smooth rotation of the rear wheels 152 about the wheel axis WA. Here, the shafts 150 may be fixed to the hubs 158 such that the rear wheels 152 rotate about the shafts 150 (e.g., about bearings supported in the rear wheels 152), or the shafts 150 could be supported for rotation relative to the hubs 158. Each of the rear wheels 152 is also provided with a wheel lock 160 coupled to its respective hub 158 to facilitate inhibiting rotation about the wheel axis WA. The wheel locks 160 are generally pivotable relative to the hubs 158, and may be configured in a number of different ways without departing from the scope of the present disclosure. While the representative version of the patient transport apparatus 100 illustrated herein employs hubs 158 with “mirrored” profiles that are coupled to the respective rear uprights 114A, 114B and support discrete shafts 150 and wheel locks 160, it will be appreciated that a single hub 158 and/or a single shaft 150 could be employed. Other configurations are contemplated.

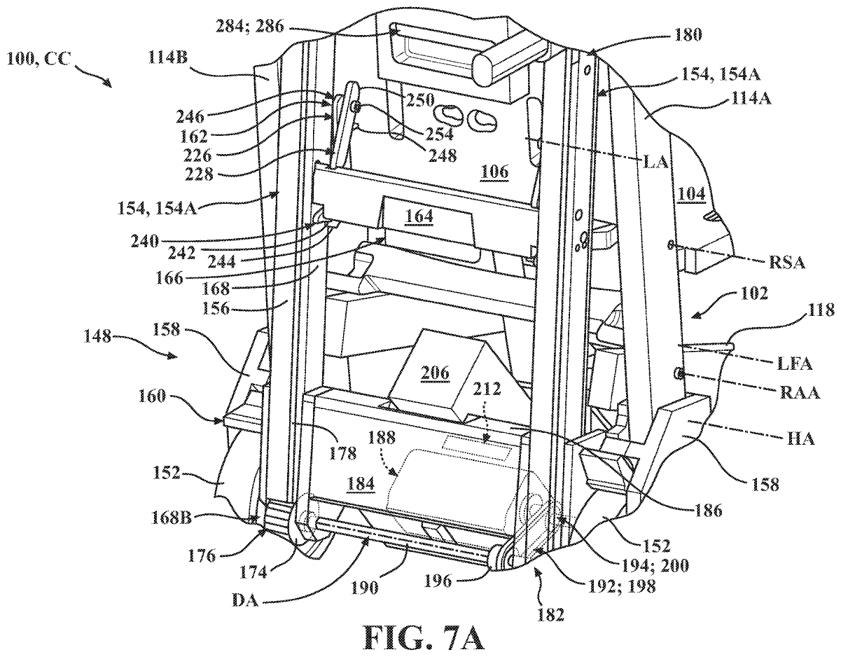

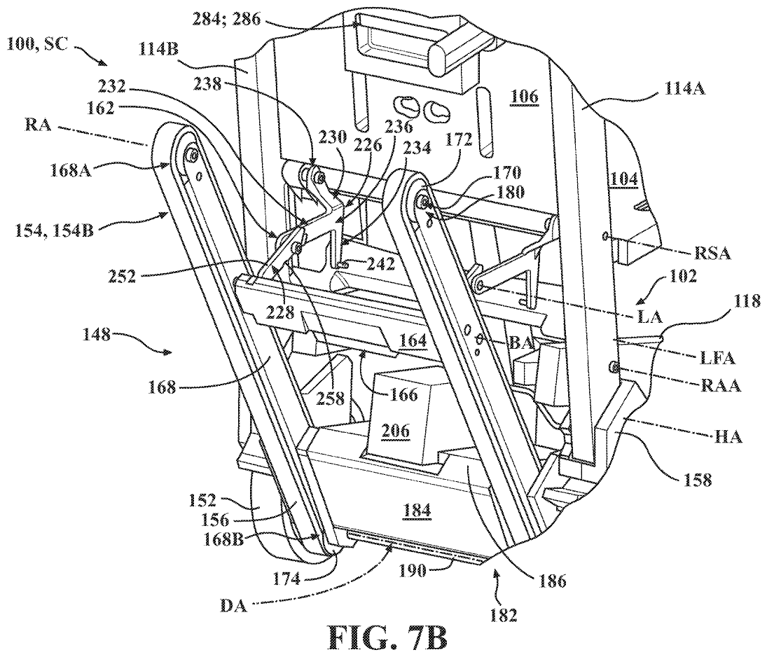

Referring now to FIGS. 7A-7B, as noted above, the track assemblies 154 move concurrently with the hubs 158 between the chair configuration CC and the stair configuration SC. Here, the track assemblies 154 are arranged in a retracted position 154A when the carrier assembly 148 is disposed in the chair configuration CC, and are disposed in a deployed position 154B when the carrier assembly 148 is disposed in the stair configuration SC. As is described in greater detail below, the illustrated patient transport apparatus 100 comprises a deployment linkage 162 and a deployment lock mechanism 164 with a deployment lock release 166 arranged for engagement by the caregiver to facilitate changing between the retracted position 154A and the deployed position 154B (and, thus, between the chair configuration CC and the stair configuration SC).

In the illustrated version, the patient transport apparatus 100 comprises laterally-spaced track assemblies 154 each having a single belt 156 arranged to contact stairs ST. However, it will be appreciated that other configurations are contemplated, and a single track assembly 154 and/or track assemblies with multiple belts 156 could be employed. The track assemblies 154 each generally comprise a rail 168 extending between a first rail end 168A and a second rail end 168B. The second rail end 168B is operatively attached to the hub 158, such as with one or more fasteners (not shown in detail). An axle 170 defining a roller axis RA is disposed adjacent to the first rail end 168A of each rail 168, and a roller 172 is supported for rotation about the roller axis RA. For each of the track assemblies 154, the belt 156 is disposed in engagement with the roller 172 and is arranged for movement relative to the rail 168 in response to rotation of the roller 172 about the roller axis RA.

Adjacent to the second rail end 168B of each rail 168, a drive pulley 174 is supported for rotation about a drive axis DA and is likewise disposed in engagement with the belt 156 (see FIGS. 7A-7B; rotation about drive axis DA not shown in detail). Here, the drive pulley 174 comprises outer teeth 176 which are disposed in engagement with inner teeth 178 formed on the belt 156. The track assemblies 154 each also comprise a belt tensioner, generally indicated at 180, configured to adjust tension in the belt 156 between the roller 172 and the drive pulley 174.

In the representative version illustrated herein, the patient transport apparatus 100 comprises a drive system, generally indicated at 182, configured to facilitate driving the belts 156 of the track assemblies 154 relative to the rails 168 to facilitate movement of the patient transport apparatus 100 up and down stairs ST. To this end, and as is depicted in FIG. 7A, the drive system 182 comprises a drive frame 184 and a cover 186 which are operatively attached to the hubs 158 of the carrier assembly 148 for concurrent movement with the track assemblies 154 between the retracted position 154A and the deployed position 154B. A motor 188 (depicted in phantom in FIG. 7A) is coupled to the drive frame 184 and is concealed by the cover 186. The motor 188 is configured to selectively generate rotational torque used to drive the belts 156 via the drive pulleys 174, as described in greater detail below. To this end, a drive axle 190 is coupled to each of the drive pulleys 174 and extends along the drive axis DA laterally between the track assemblies 154. The drive axle 190 is rotatably supported by the drive frame 184, such as by one or more bearings, bushings, and the like (not shown in detail). A geartrain 192 is disposed in rotational communication between the motor 188 and the drive axle 190. To this end, in the version depicted in FIG. 7A, the geartrain 192 comprises a first sprocket 194, a second sprocket 196, and an endless chain 198. Here, the motor 188 comprises an output shaft 200 to which the first sprocket 194 is coupled, and the second sprocket 196 is coupled to the drive axle 190. The endless chain 198, in turn, is supported about the first sprocket 194 and the second sprocket 196 such that the drive axle 190 and the output shaft 200 rotate concurrently. The geartrain 192 may be configured so as to adjust the rotational speed and/or torque of the drive axle 190 relative to the output shaft 200 of the motor, such as by employing differently-configured first and second sprockets 194, 196 (e.g., different diameters, different numbers of teeth, and the like).

While the representative version of the drive system 182 illustrated herein utilizes a single motor 188 to drive the belts 156 of the track assemblies 154 concurrently using a chain-based geartrain 192, it will be appreciated that other configurations are contemplated. By way of non-limiting example, multiple motors 188 could be employed, such as to facilitate driving the belts 156 of the track assemblies 154 independently. Furthermore, different types of geartrains 192 are contemplated by the present disclosure, including without limitation the geartrains 192 which comprise various arrangements of gears, planetary gearsets, and the like.

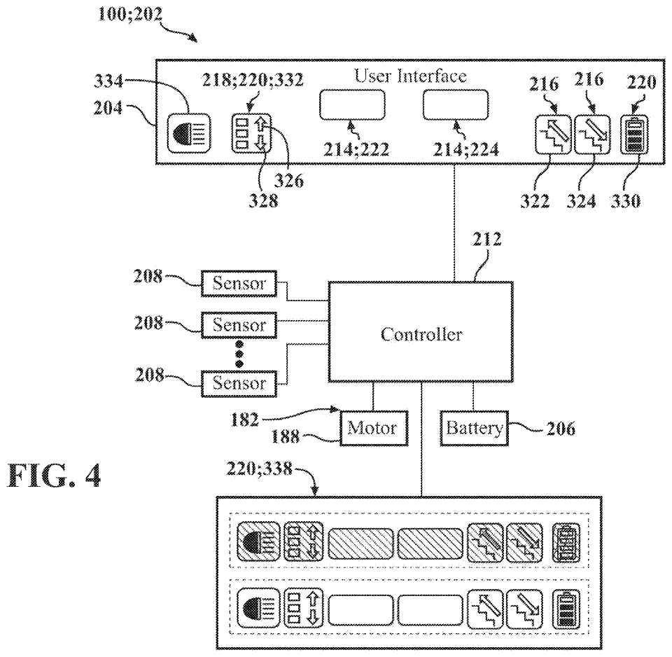

The patient transport apparatus 100 comprises a control system 202 to, among other things, facilitate control of the track assemblies 154. To this end, and as is depicted schematically in FIG. 4, the representative version of the control system 202 generally comprises a user interface 204, a battery 206, one or more sensors 208, and one or more back light modules 210 which are disposed in electrical communication with a controller 212. As will be appreciated from the subsequent description below, the controller 212 may be of a number of different types, styles, and/or configurations, and may employ one or more microprocessors for processing instructions or an algorithm stored in memory to control operation of the motor 188, the light modules 210, and the like. Additionally or alternatively, the controller 212 may comprise one or more sub-controllers, microcontrollers, field programmable gate arrays, systems on a chip, discrete circuitry, and/or other suitable hardware, software, and/or firmware that is capable of carrying out the functions described herein.

The controller 212 is coupled to various electrical components of the patient transport apparatus 100 (e.g., the motor 188) in a manner that allows the controller 212 to control or otherwise interact with those electrical components the (e.g., via wired and/or wireless electrical communication). In some versions, the controller 212 may generate and transmit control signals to the one or more powered devices, or components thereof, to drive or otherwise facilitate operating those powered devices, or to cause the one or more powered devices to perform one or more of their respective functions.

The controller 212 may utilize various types of sensors 208 of the control system 202, including without limitation force sensors (e.g., load cells), timers, switches, optical sensors, electromagnetic sensors, motion sensors, accelerometers, potentiometers, infrared sensors, ultrasonic sensors, mechanical limit switches, membrane switches, encoders, and/or cameras. One or more sensors 208 may be used to detect mechanical, electrical, and/or electromagnetic coupling between components of the patient transport apparatus 100. Other types of sensors 208 are also contemplated. Some of the sensors 208 may monitor thresholds movement relative to discrete reference points. The sensors 208 can be located anywhere on the patient transport apparatus 100, or remote from the patient transport apparatus 100. Other configurations are contemplated.

The battery 206 provides power to the controller 212, the motor 188, the light modules 210, and other components of the patient transport apparatus 100 during use, and is removably attachable to the cover 186 of the drive system 182 in the illustrated version (see FIG. 7A; attachment not shown in detail). The user interface 204 is generally configured to facilitate controlling the drive direction and drive speed of the motor 188 to move the belts 156 of the track assembly 154 and, thus, allow the patient transport apparatus 100 to ascend or descend stairs ST. Here, the user interface 204 may comprise one or more activation input controls 214 to facilitate driving the motor 188 in response to engagement by the caregiver, one or more direction input controls 216 to facilitate changing the drive direction of the motor 188 in response to engagement by the caregiver, and/or one or more speed input controls 218 to facilitate operating the motor 188 at different predetermined speeds selectable by the caregiver. The user interface 204 may also comprise various types of indicators 220 to display information to the caregiver. It will be appreciated that the various components of the control system 202 introduced above could be configured and/or arranged in a number of different ways, and could communicate with each other via one or more types of electrical communication facilitated by wired and/or wireless connections. Other configurations are contemplated.

In the illustrated versions, the patient transport apparatus 100 is configured to limit movement of the belts 156 relative to the rails 168 during transport along stairs ST in an absence of engagement with the activation input controls 214 by the caregiver. Put differently, one or more of the controller 212, the motor 188, the geartrain 192, and/or the track assemblies 154 may be configured to “brake” or otherwise prevent movement of the belts 156 unless the activation input controls 214 are engaged. To this end, the motor 188 may be controlled via the controller 212 to prevent rotation (e.g., driving with a 0% pulse-width modulation PWM signal) in some versions. However, other configurations are contemplated, and the patient transport apparatus 100 could be configured to prevent movement of the belts 156 in other ways. By way of non-limiting example, a mechanical brake system (not shown) could be employed in some versions.

Referring now to FIG. 7A, the patient transport apparatus 100 employs the deployment lock mechanism 164 to releasably secure the track assembly 154 in the retracted position 154A and in the deployed position 154B. The deployment lock release 166 is arranged for engagement by the caregiver to move between the retracted position 154A and the deployed position 154B. The deployment lock mechanism 164 is coupled to the track assemblies 154 for concurrent movement, and the deployment linkage 162 is coupled between the deployment lock mechanism 164 and the support structure 102. The illustrated deployment linkage 162 generally comprises connecting links 226 which are pivotably coupled to the support structure 102, and brace links 228 which are coupled to the deployment lock mechanism 164 and are respectively pivotably coupled to the connecting links 226.

The connecting links 226 each comprise or otherwise define a forward pivot region 230, a connecting pivot region 232, a trunnion region 234, and an interface region 236. The forward pivot regions 230 extend from the interface regions 236 to forward pivot mounts 238 which are pivotably coupled to the rear uprights 114A, 114B about the rear seat axis RSA, such as by one or more fasteners, bushings, bearings, and the like (not shown in detail). Here, because the rear uprights 114A, 114B are spaced laterally away from each other at a distance large enough to allow the track assemblies 154 to “nest” therebetween in the retracted position 154A (see FIG. 7A), the forward pivot regions 230 of the connecting links 226 extend at an angle away from the rear uprights 114A, 114B at least partially laterally towards the track assemblies 154.

The trunnion regions 234 extend generally vertically downwardly from the interface regions 236 to trunnion mount ends 240, and comprise trunnions 242 which extend generally laterally and are arranged to abut trunnion catches 244 of the deployment lock mechanism 164 to retain the track assemblies 154 in the retracted position 154A (see FIG. 7A). The connecting pivot regions 232 extend longitudinally away from the interface regions 236 to rearward pivot mounts 246 which pivotably couple to the brace links 228 about a link axis LA. The connecting links 226 are each formed as separate components with mirrored profiles in the illustrated versions, but could be realized in other ways, with any suitable number of components.

The brace links 228 each generally extend between an abutment link end 250 and a rearward link mount 252, with a forward link mount 254 arranged therebetween. The forward link mounts 254 are pivotably coupled to the rearward pivot mounts 246 of the connecting links 226 about the link axis LA, such as by one or more fasteners, bushings, bearings, and the like (not shown in detail). The rearward link mounts 252 are each operatively attached to the deployment lock mechanism 164 about a barrel axis BA. The brace links 228 each define a link abutment surface 256 disposed adjacent to the abutment link end 250 which are arranged to abut the link stops 248 of the connecting links 226 in the deployed position 154B (see FIG. 7B). The brace links 228 also define a relief region 258 formed between the forward link mount 254 and the rearward link mount 252. The relief regions 258 are shaped to at least partially accommodate the link stops 248 of the connecting links 226 when the track assemblies 154 are in the retracted position 154A (not shown in detail). The deployment linkage 162, the deployment lock mechanism 164, and the deployment lock release 166 may be similar to as is disclosed by U.S. Patent Application Publication No. 20210196536, the disclosure of which is hereby incorporated by reference in its entirety.

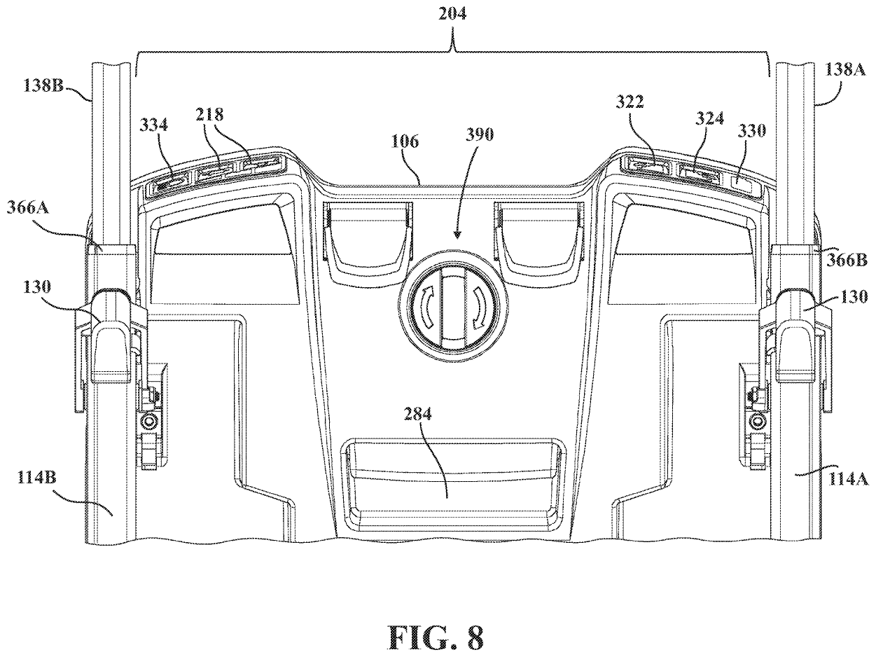

With continued reference to FIGS. 7A and 7B and additional reference to FIG. 8, the patient transport apparatus 100 employs a folding lock mechanism 284 to facilitate changing between the stowed configuration WC (see FIG. 5) and the chair configuration CC (see FIG. 6A). To this end, the folding lock mechanism 284 generally comprises a folding lock release 286 operatively attached to the back section 106 and arranged for engagement by the caregiver to releasably secure the folding lock mechanism 284 between a stow lock configuration to maintain the stowed configuration WC, and a use lock configuration to prevent movement to the stowed configuration WC from the chair configuration CC or from the stair configuration SC. The folding lock mechanism 284 may incorporate features as disclosed in U.S. Pat. No. 6,648,343 previously incorporated by reference and as disclosed in U.S. Patent Application Publication No. 20210196536, previously incorporated by reference.

The drive system 182 may include various components not specifically illustrated or be configured in various ways not discussed in detail but described in U.S. Patent Application Publication No. 20210196536, previously referenced and incorporated by reference. In a version, the motor 188 may be supported on an adjustable platform that is movable relative to the drive frame 184 to adjust slack in the endless chain. This arrangement helps to optimize power density and minimize weight in the drive system 182. It will be appreciated that this arrangement could be utilized with other types of geartrains 192, such as where a belt drive (not shown) would replace the endless chain 198. Other configurations are contemplated.

In some versions, the geartrain 192 may be configured with a direct drive gearbox coupled to one of the rails 168 of the track assembly 154. Here, the drive axle 190 extends through the direct drive gearbox, and the motor 188 may be coupled to the direct drive gearbox. In some versions, the patient transport apparatus 100 may include a “passive brake” that allows the speed of the patient transport apparatus 100 to be controlled when on stairs ST even when the battery 206 is of low charge, dead, or not connected to the drive system 182 (e.g., inadvertently removed).

FIGS. 9A-9F successively depict exemplary steps of transporting a patient supported on the patient transport apparatus 100 down the stairs ST. In FIG. 9A, a first caregiver is shown engaging the pivoting handle assemblies 130 in the engagement position 130B to illustrate approaching stairs ST while the patient transport apparatus 100 is moved along floor surfaces FS in the chair configuration CC. In FIG. 9B, the patient transport apparatus 100 has been moved closer to the stairs with a second caregiver engaging the front handle assemblies 128 after having moved them to the extended position 128B. The deployment lock release 166 was also deployed by the first caregiver to move the patient transport apparatus 100 into the stair configuration SC as shown. As shown in the stair configuration SC, the track assemblies 154 are arranged in the deployed position 154B. Here, the rear wheels 152 are positioned significantly closer to the front wheels 122 compared to operation in the chair configuration CC, and are also arranged further under the seat section 104. It will be appreciated that transitioning the patient transport apparatus 100 from the chair configuration CC to the stair configuration SC has resulted in minimal patient movement relative to the support structure 102 as the carrier assembly 148 pivots about the hub axis HA and moves the rear wheels 152 closer to the front wheels 122 in response to movement of the track assemblies 154 to the deployed position 154B.

Furthermore, while the arrangement of the patient's center of gravity has not changed significantly relative to the support structure 102, the longitudinal distance which extends between the patient's center of gravity and the location at which the rear wheels 152 contact the floor surface FS has shortened considerably. Because of this, the process of “tilting” the patient transport apparatus 100 (e.g., about the rear wheels 152) to transition toward contact between the track assemblies 154 and the stairs ST, as depicted in FIG. 9C, is significantly more comfortable for the patient than would otherwise be the case if the patient transport apparatus 100 were “tilted” about the rear wheels 152 from the chair configuration CC (e.g., with the rear wheels 152 positioned further away from the front wheels 122). Put differently, the arrangement depicted in FIG. 9C is such that the patient is much less likely to feel uncomfortable, unstable, or as if they are “falling backwards” during the “tilting” process. Here too, the caregivers are afforded with similar advantages in handling the patient transport apparatus 100, as the arrangement of the rear wheel 152 described above also makes the “tilting” process easier to control and execute. In FIG. 9D, the caregivers are shown continuing to support the patient transport apparatus 100 in the stair configuration SC as the belts 156 of the track assemblies 154 are brought into contact with the edge of the top stair ST.

In FIGS. 9E and 9F, the caregivers are shown continuing to support the patient transport apparatus 100 in the stair configuration SC as the belts 156 of the track assemblies 154 contact multiple stairs ST during descent

The patient transport apparatus 100 is configured to operate in a variety of states and modes in certain versions, including for example in or between one or more inactive states SI and/or one or more active states SA. During the inactive state SI, power consumption of the patient transport apparatus 100 is limited as the motor is not controlling movement of the belt during this state, and during the active state SA the controller 212 may be utilized to control movement of the belt 156 with the motor 188 of the patient transport apparatus 100.

It will be appreciated that the controller 212 may be configured to operate in a variety of inactive states SI and active states SA. The controller 212 may be configured to operate in (or between) a sleep mode MS of the inactive state SI and an active mode MS of the inactive state SI. The controller 212 may also operate in a variety of inactive states, for example, a low charge mode MLC of the inactive state SI, and/or a battery disconnect mode MBD of the inactive state SI which are discussed in detail in U.S. Patent Application Publication No. 20210196539A1, the disclosure of which is hereby incorporated by reference in its entirety.

During the sleep mode MS of the inactive state SI, power consumption of the patient transport apparatus 100 is limited. In some versions, power consumption of the patient transport apparatus 100 may be limited by only allowing the controller 212 to provide power from the battery 206 to certain components of the patient transport apparatus 100. For example, during the sleep mode MS, the controller 212 may be unable to generate and transmit control signals to some of the one or more powered devices, or components thereof, to drive the patient transport apparatus 100. Here, however, the controller 212 may be configured to provide power to the user interface 204. In the sleep mode MS, the user interface 204 may be prevented from emitting light, but may be configured to receive input generate by user engagement of any portion of the user interface 204. Additionally, in some instances of the sleep mode MS, one or more of the controller 212, the motor 188, the geartrain 192, and/or the track assemblies 154 may also be configured to “brake” or otherwise prevent movement of the belts 156.

During active mode MA of the inactive state, the controller 212 may not limit power consumption of any component of the patient transport apparatus 100. For example, the user interface 204 may emit light for a predetermined period of time in response to user engagement of one of the input controls 214, 216, 218, 222, 224, 322, 324, 326, 328, and 334. Various other components of the patient transport apparatus 100 may be provided power upon demand without limitation during the active mode MA of the inactive state SI.

The controller 212 may be configured to operate in a drive mode MD during the active state SA to control a direction of movement of the belt 156. In some versions, the controller 212 may be configured to additionally operate in additional modes to the drive mode during the active state SA such as a hold mode MH of the active state SA for limiting movement of the belt 156 to facilitate a controlled descent of the patient transport apparatus 100 along stairs ST. The hold mode is disclosed by the discussed in detail in U.S. Patent Application Publication No. 20210196539A1, previously incorporated by reference.

In some versions, the user interface 204 may comprise one or more light modules 210 realized as backlight modules 338 arranged to illuminate various input controls 214, 216, 218, 222, 224, 322, 324, 326, 328, 334 and/or indicators 220, 330, 32 under certain operating conditions. In some versions, the user interface 204 may comprise one or more light modules 210 configured to, among other things, provide status information to the caregiver.

In the representative version illustrated herein, the controller 212 may be operable in sleep mode in which power consumption is limited, and the active mode SA in which power consumption is not limited such as when the controller 212 controls movement of the belt 156 with the motor 188 of the patient transport apparatus 100. As previously described, the controller 212 may be configured to operate in a variety of other modes/states not explicitly discussed herewith but discussed in greater detail in U.S. Patent Application Publication No. 20210196539A1, previously incorporated by reference.

As noted above, the direction input controls 216 may include the first direction input control 322 and the second direction input control 324. Here, the first direction input control 322 may be configured to select a drive direction of the motor 188 in order to ascend stairs. The second direction input control 324 may be configured to select a drive direction of the motor 188 in order to descend stairs.

The one or more speed input controls 218 may be configured to select between the plurality of drive speeds DS1, DS2, DS3 of the motor 188. The speed indicator 332 may be disposed adjacent to the one or more speed input controls 218. The speed indicator 332 may be configured to display the selected one of the plurality of drive speeds DS1, DS2, DS3 of the motor 188 to the user.

The plurality of drive speeds DS1, DS2, DS3 may correspond to predetermined speed settings (a specific RPM setting) stored in memory of the controller 212. The plurality of drive speeds DS1, DS2, DS3 may include a first drive speed DS1, a second drive speed DS2, and a third drive speed DS3. The first drive speed DS1 corresponds to the lowest of the plurality of drive speeds DS1, DS2, DS3. The third drive speed DS3 corresponds to the highest drive speed of the plurality of drive speeds DS1, DS2, DS3. The second drive speed DS2 corresponds to a speed in between the first drive speed DS1 and the third drive speed DS3. It will be appreciated that the forgoing are non-limiting, illustrative examples of three discreet drive speeds, and other configurations are contemplated, including without limitation additional and/or fewer drive speeds, drive speeds defined in other ways, and the like.

As noted above, the one or more speed input controls 218 may include a first speed input control 326 and a second speed input control 328. The controller 212 may be configured to increase the selected speed to the next higher drive speed setting in response to the user engagement of the first speed input control 326. For example, in response to receiving user input generated by user engagement of the first speed input control 326 when the current selected drive speed is the first drive speed DS1, the controller 212 may set the current speed to the second drive speed DS2. The controller 212 may be configured to decrease the selected drive speed to the next lower drive speed setting in response to user engagement of the second speed input control 328. For example, when the current selected drive speed is the second drive speed DS2, the controller 212 may set the current speed to the first drive speed DS1 in response to user engagement of the second speed input control 328.

In some versions, the controller 212 may be configured to initially select the first drive speed DS1 of the plurality of drive speeds DS1, DS2, DS3 in response to user engagement of the direction input controls 216 following the change in operation from the inactive state SI to the active state SA. However, it is contemplated that the controller 212 may be configured alternatively, such as to initially select the second drive speed DS2 or the third drive speed DS3 of the plurality of drive speeds DS1, DS2, DS3.

The controller 212 may be configured to selectively permit operation of the motor 188 in response to receiving user input generated by engagement of one of the activation input controls 214 (e.g., the first activation input control 222 or the second activation input control 224). For example, the controller 212 may be configured to permit operation of the motor 188 in response to user engagement of at least one of the activation input controls 214 following user engagement of the direction input control 216 to drive the belt 156 in a selected drive direction. In another example, the controller 212 may be configured to permit operation of the motor 188 in response to user engagement of the activation input controls 214 within a predetermined period following engagement of the direction input control 216. . After the predetermined period following user engagement of the direction input control 216 has elapsed, the controller 212 may prevent operation of the motor 188 even when one of the activation input controls 214 is engaged. The controller 212 may also be configured to limit operation of the motor 188 in response to receiving the user input before receiving the user input generated by user selection of one of the direction input controls 216.

As is best depicted in FIG. 6B, the rear uprights 114A, 114B each generally extend between a lower upright end 115A and an upper upright end 115B, with the hub axis HA arranged adjacent to the lower upright end 115A. The lower upright end 115A is supported for movement within the hub 158, which may comprise a hollow profile or recess defined by multiple hub housing components. In the illustrated version, the hub axis HA is arranged generally vertically between the rear arm axis RAA and the wheel axis WA.

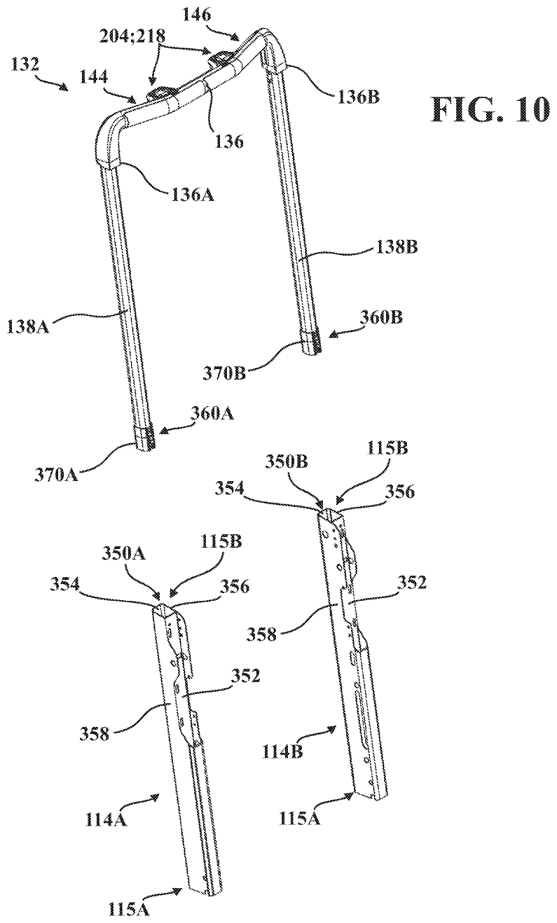

The rear uprights 114A, 114B may each comprise a generally hollow, extruded profile which supports various components of the patient transport apparatus 100. Referring to FIG. 10, the first rear upright 114A defines a first support channel 350A. Likewise, the second rear upright 114B may define a second support channel 350B. For example, the first and/or second rear uprights 114A, 114B may each include a front wall 352, a rear wall 354 spaced from the front wall 352, a first lateral wall 356 extending between the front wall 352 and the rear wall 354, and a second lateral wall 358 spaced from the first lateral wall 356 and extending between the front wall 352 and the rear wall 354. Cumulatively, the front wall 352, the rear wall 354, and the first lateral wall 356, and the second lateral wall 358 may define the first and/or second support channel 350A, 350B. In some examples, the first and/or second support channel 350A, 350B may define a rounded rectangular profile.

With continued reference to FIG. 10, the handle assembly 132 includes an upper grip 136. The upper grip 136 is operatively attached to a first extension post 138A. The first extension post 138A is disposed within the first support channel 350A of the first rear upright 114A. Accordingly, the first extension post 138A supports the upper grip 136 for movement of the handle assembly 132 between a collapsed position 132A where the upper grip is disposed adjacent to the user interface (see FIG. 1) and an extended position 132B where the upper grip is spaced from the user interface (see FIG. 2). In some examples, the upper grip 136 may extend between a first upper grip end 136A and a second upper grip end 136B. The first extension post 138A may be operatively attached to the first upper grip end 136A. The handle assembly 132 may further include a second extension post 138B operatively attached to the second upper grip end 136B. Together, the first and second extension posts 138A, 138B may support the upper grip 136 for movement of the handle assembly 132 between the collapsed position 132A and the extended position 132B. The first and/or second extension posts 138A, 138 may define a rounded rectangular profile corresponding to the profile of the first and/or second support channel 350A, 350B.

In the representative version illustrated herein, the upper grip 136 generally comprises a first hand grip region 144 arranged adjacent to the first extension posts 138A, and a second hand grip region 146 arranged adjacent to the second extension post 138B, each of which may be engaged by the caregiver to support the patient transport apparatus 100 for movement, such as during patient transport up or down stairs ST (see FIGS. 9A-9F). The activation input controls 214 may be arranged in various locations about the patient transport apparatus. In the illustrated versions, a first activation input control 222 is disposed adjacent to the first hand grip region 144 of the handle assembly 132, and a second activation input control 224 is disposed adjacent to the second hand grip region 146 (best shown in FIG. 1). In the illustrated version, the user interface 204 is configured such that the caregiver can engage either of the activation input controls 222, 224 with a single hand grasping the upper grip 136 (described below) of the handle assembly 132 during use.

The activation input controls 214 may be arranged between the first and second hand grip regions 144, 146 in order to facilitate user engagement of the activation input controls 214 from either of the first and second hand grip regions 144, 146. As previously discussed, the activation input controls 214 include the first activation input control 222 and the second activation input control 224. The first activation input control 222 may be disposed adjacent the first hand grip region 144 so as to facilitate user engagement of the first activation input control 222 from the first hand grip region 144. The second activation input control 224 may be disposed adjacent to the second hand grip region 146 so as to facilitate user engagement of the second activation input control 224 from the second hand grip region 146. Here, it will be appreciated that the user can engage either of the first and second hang grip regions 144, 146 with one of their hands to support the patient transport apparatus 100 while, at the same, using that same hand to activate one of the first and second activation input controls 222, 224 (e.g., reaching with their thumb). The first activation input control 222 and the second activation input control 224 may be spaced apart by a predetermined distance (e.g., several inches) and may be wired in parallel in some versions (not shown in detail).

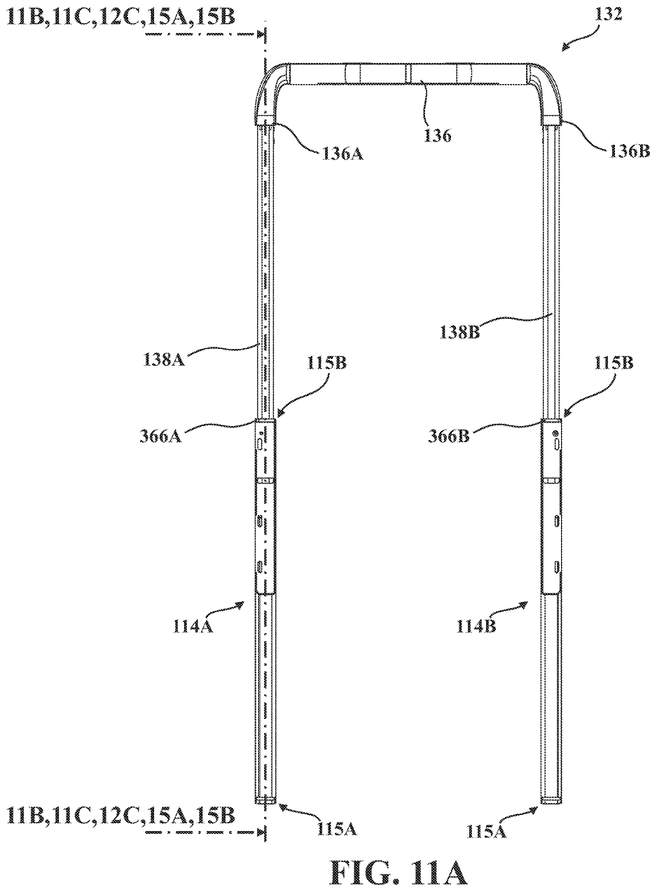

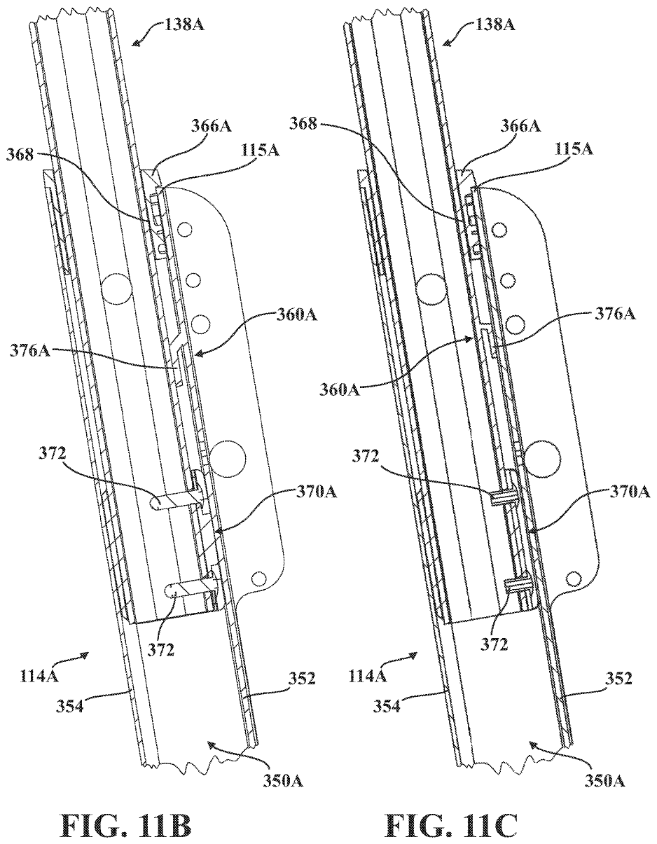

Referring to FIGS. 11A-11C, the patient transport apparatus 100 further includes a first damper 360A. The first damper 360A is interposed between the first support channel 350A and the first extension post 138A. The first damper 360A controls movement of the first extension post 138A as the handle assembly 132 moves from the extended position 132A to the collapsed position 132B. For example, the first damper 360A may slow translation of the first extension post 138A within the first support channel 350A. Referring back to FIG. 1, the handle assembly 132 and the user interface 204 may define a pinch area 362 between the handle assembly 132 and the user interface 204 when the handle assembly 132 is near the collapsed position 132A. A user's hands may be vulnerable to being pinched between the handle assembly 132 and the user interface 204 when the handle assembly 132 moves into the pinch area 362. Accordingly, the first damper 360A slows translation of the first extension member 360A within the first support channel 350A to slow movement of the handle assembly 132 as the handle assembly 132 enters the pinch area 362 to prevent pinching a user's hand. In examples where the handle assembly 132 includes the second extension post 138B, the patient transport apparatus 100 may further include a second damper 360B interposed between the second support channel 350B and the second extension post 138B. Likewise, the second damper 360B controls movement of the first extension post 138A as handle assembly 132 moves from the extended position 132A to the collapsed position 132B, such as into the pinch area 362.

As best shown in FIGS. 11B through 11C, the first rear upright 114A may include a first bushing 366A. Also, the second rear upright 114B may include a second bushing 366B (best shown in FIG. 8). The first and second bushings 366A, 366B may be disposed in the upper upright end 115A of the first support channel 350A and the second support channel 350B, respectively. The first and second bushings 366A, 366B are configured to guide movement of the first extension post 138A within the first support channel 350A and to guide movement of the second extension post 138B within the second support channel 350B, respectively. For example, the first and second bushings 366A, 366B may each define a race 368 configured to abut the first the first extension post 138A and the second extension post 138B, respectively. The race 368 of each of the first bushing 366A and the second bushing 366B guide movement of the first extension post 138A within the first support channel 350A and to guide movement of the second extension post 138B within the second support channel 350B, respectfully. While FIGS. 11B through 14B show only the first bushing 366A, it should be appreciated that the second bushing 366B may have the same or similar structure. Other configurations are contemplated, and the first and second bushings 366A, 366B may be arranged in various ways to guide movement of the first extension post 138A within the first support channel 350A and to guide movement of the second extension post 138B within the second support channel 350B, respectively.

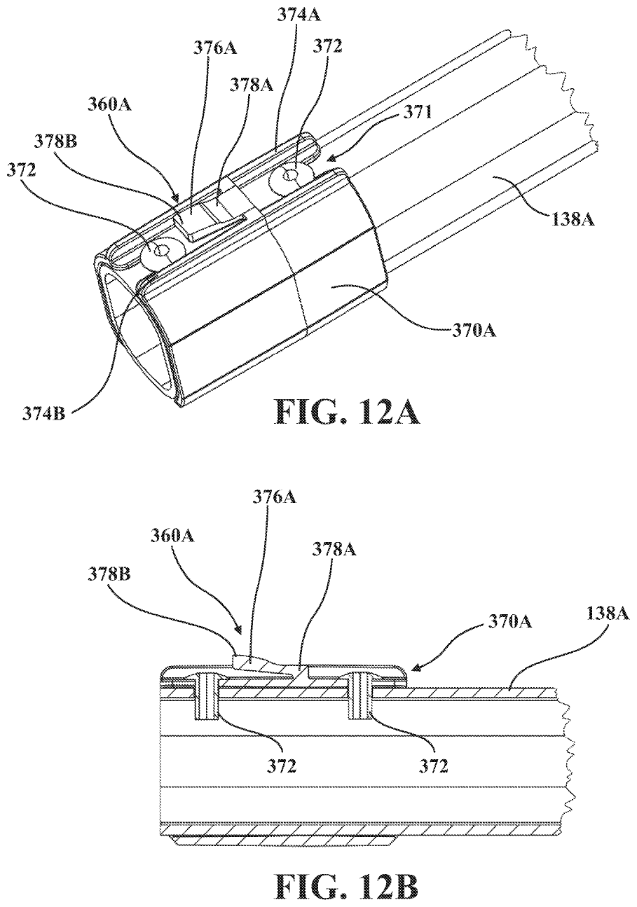

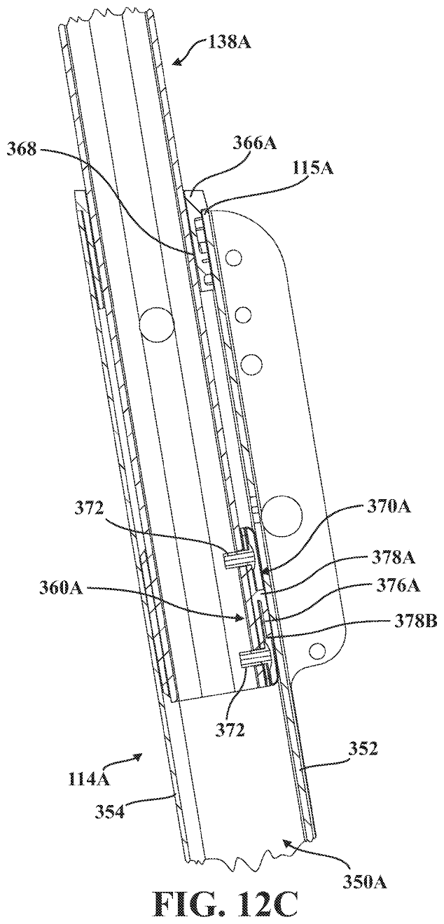

Additionally, referring to FIGS. 11B through 14B, the first extension post 138A may include a first collar 370A, and the second extension post 138B may include a second collar 370B. The first collar 370A and the second collar 370B may be coupled to the end of the first extension post 138A and the second extension post 138B, respectively. For example, the first collar 370A and the second collar 370B may be coupled to the end of the first extension post 138A and the second extension post 138B, respectively, using fasteners 372. The first collar 370A is configured to guide movement of the first extension post 138A within the first support channel 350A, and the second collar 370B is configured to guide movement of the second extension post 138B within the second support channel 350B. In one example, as best shown in FIGS. 12A, 13A, and 14A, the first collar 370A and the second collar 370B may each include a first land 374A and a second land 374B spaced from the first land 374A. The first and second lands 374A, 374B are each configured to abut one of the front wall 352 and the rear wall 354 to guide movement of the first or second extension post 138A, 138B within the first or second support channel 350A, 350B, respectively. In some examples, the first and second lands 374A, 374B may define a tapered profile. While FIGS. 11B through 14B show only the first collar 370A, it should be appreciated that the second collar 370B may have the same or similar structure. Other configurations are contemplated.

With continued reference to FIGS. 11B through 14B, in one example, the first damper 360A may include a first deflectable member 376A. The first deflectable member 376A may be operatively attached to one of the first extension post 138A and the first support channel 350A. The first deflectable member 376A may be configured to abut the other of the first extension post 138A and the first support channel 350A to control movement of the first extension post 138A as the handle assembly 132 moves from the extended position 132A to the collapsed position 132B. For example, referring to FIGS. 11B and 11C, the first deflectable member 376A abuts one of the first extension posts 138A and the first support channel 350A to generate friction to slow translation of the first extension post 138A within the first support channel 350A. FIG. 11B shows the first deflectable member 376A operatively attached to the first support channel 350A and abutting the first extension post 138A to control movement of the first extension post 138A as the handle assembly 132 moves from the extended position 132A to the collapsed position 132B. FIG. 11C, on the other hand, shows the first deflectable member 376A operatively attached to first extension post 138A and abutting the first support channel 350A to control movement of the first extension post 138A as the handle assembly 132 moves from the extended position 132A to the collapsed position 132B. Similarly, the second damper 360B may include a second deflectable member 376B. The second deflectable member 376B may be operatively attached to one of the second extension post 138A and the second support channel 350B. The second deflectable member 376B may be configured to abut the other of the second extension posts 138B and the second support channel 350B to control movement of the second extension post 138B as the handle assembly 132 moves from the extended position 132A to the collapsed position 132B. While FIGS. 11B through 14B show only the first damper 360A including the first deflectable member 376A, it should be appreciated that the second damper 360B including the second deflectable member 376B may have the same or similar structure as described above in the context of the first deflectable member 376A.

In some configurations, the first deflectable member 376A of the first damper 360A may be coupled to the first collar 370A. Here, the first deflectable member 376A is configured to abut the first support channel 350A to control movement of the first extension post 138A as the handle assembly 132 moves from the extended position 132B to the collapsed position 132A. In some examples, the first collar 370A defines a collar channel 371 between the first land 374A and the second land 374B, and the first deflectable member 376A is disposed in the collar channel 371. Similarly, the second deflectable member 376B of the second damper 360B may be coupled to the second collar 370B and configured to abut the second support channel 350B to control movement of the second extension post 138B as the handle assembly 132 moves from the extended position 132B to the collapsed position 132A. Referring to FIGS. 12A through 14B, various examples of the first deflectable member 376A coupled to the first collar 370A are shown. While FIGS. 12A through 14B show only the first damper 360A including the first deflectable member 376A coupled to the first collar 370A, it should be appreciated that the second damper 360B including the second deflectable member 376B coupled to the second collar 370B may have the same or similar structure.

In one example, referring to FIGS. 12A through 12C, the first deflectable member 376A and the first collar 370A may be integrally formed as a unitary component. In this example, the first deflectable member 376A extends between a first end 378A and a second end 378B. The first end 378A may extend from the first collar 370A and the second end 378B may extend away from the first extension post 138A such that the second end 378B is arranged to abut the first support channel 350A to control movement of the first extension post 138A as the handle assembly 132 moves from the extended position 132A to the collapsed position 132B. Particularly, referring to FIG. 12C, the second end 378B of the deflectable member 376A is configured to deflect when the first extension post 138A is disposed in the first support channel 350A such that the second end 378B abuts the first support channel 350A to generate friction to control movement of the first extension post 138A as the handle assembly 132 moves from the extended position 132A to the collapsed position 132B. Of course, it should be appreciated that the second damper 360B including the second deflectable member 376B coupled to the second collar 370B may have the same or similar structure as described above.

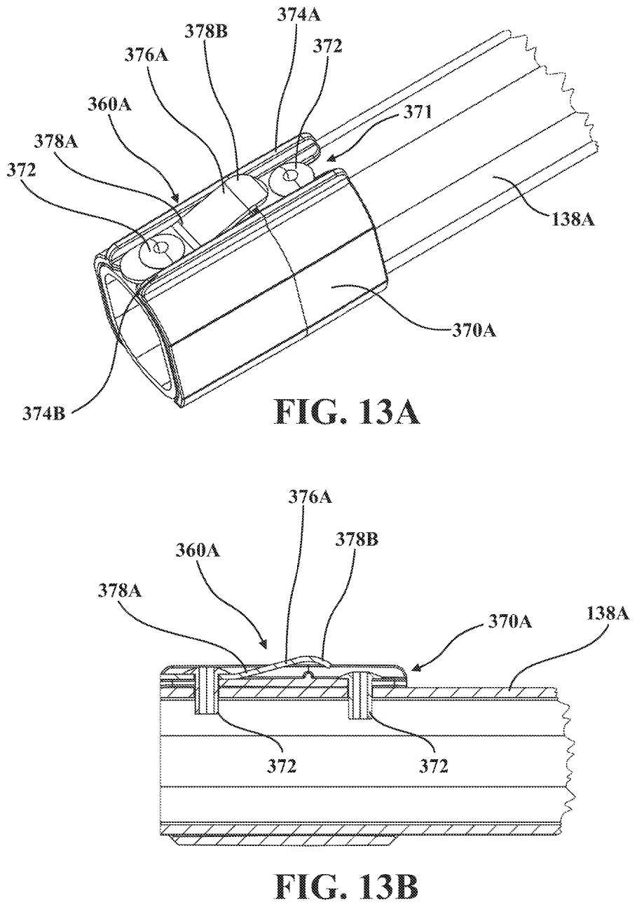

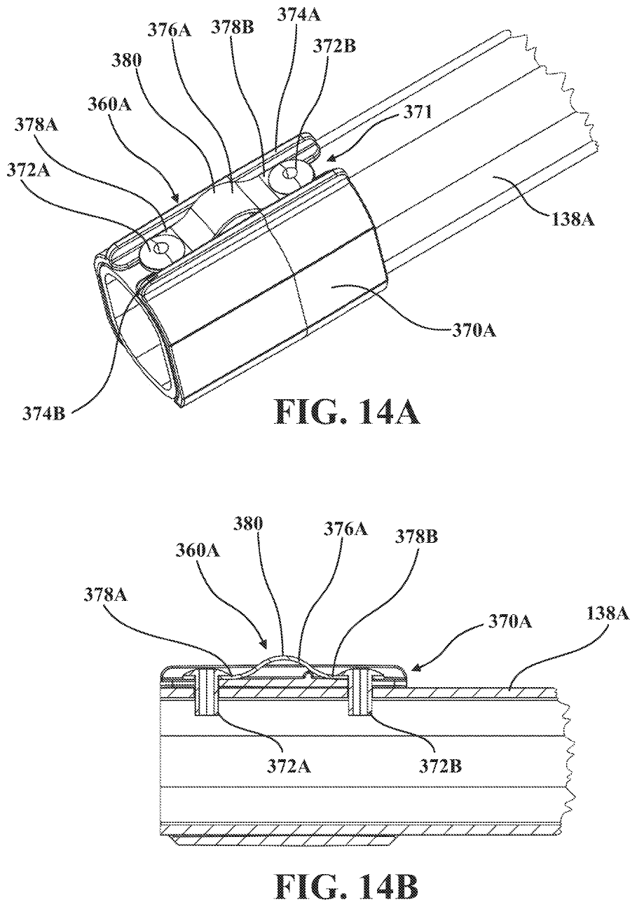

In other examples, the first damper 360A further includes one or more fasteners 372 disposed through the first deflectable member 376A to couple the first deflectable member 376A to the first collar 370A. In one example, referring to FIGS. 13A and 13B, the first deflectable member 376A extends between the first end 378A and the second end 378B. In this example, a fastener 372 is disposed through the first end 378A of the first deflectable member 376A to couple the first end 378A of the deflectable member 376B to the first collar 370A. The second end 378B may extend away from the first extension post 138A such that the second end 378B is arranged to abut the first support channel 350A to control movement of the first extension post 138A as the handle assembly 132 moves from the extended position 132A to the collapsed position 132B. In another example, referring to FIGS. 14A and 14B, the first deflectable member 376A extends between the first end 378A and the second end 378B. In this example, a first fastener 372A is disposed through the first end 378A of the first deflectable member 376A to couple the first end 378A of the deflectable member 376B to the first collar 370A. Additionally, a second fastener 372B is disposed through the second end 378B of the first deflectable member 376A to couple the second end 378B of the deflectable member 376A to the first collar 370A. Here, the first deflectable member 376A defines an arch 380 between the first end 378A and the second end 378B configured to abut the first support channel 350B to control movement of the first extension post 138A as the handle assembly 132 moves from the extended position 132B to the collapsed position 132A. Of course, it should be appreciated that the second damper 360B including the second deflectable member 376B coupled to the second collar 370B may have the same or similar structure as described above.

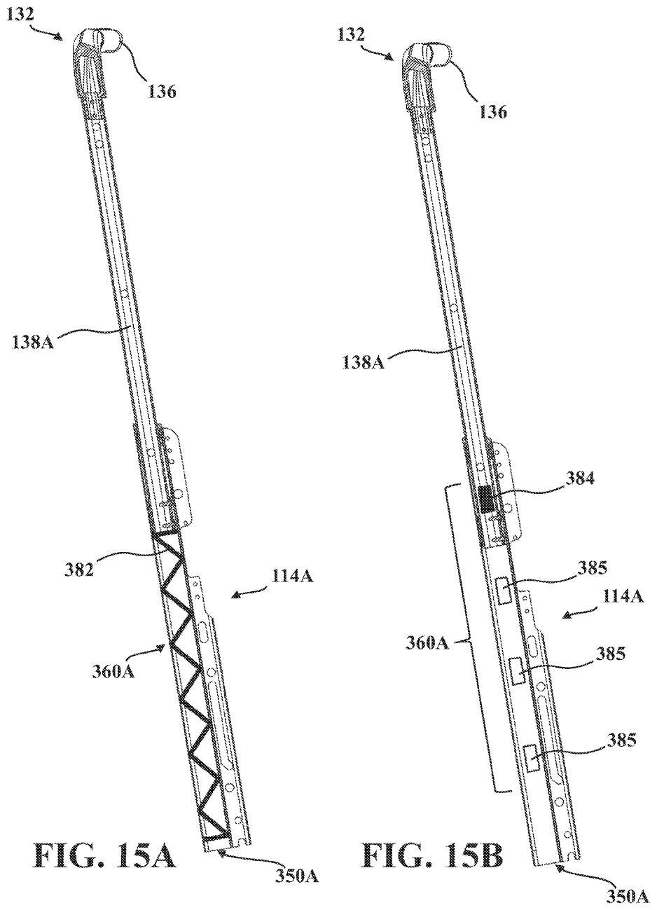

Other configurations of the first damper 360A and/or the second damper 360B are contemplated. For example, referring to FIG. 15A, the first damper 360A and/or the second damper 360B may each include a spring 382 disposed within the first and second support channels 350A, 350B, respectively. The spring(s) 382 may abut the bottom of the first and/or second extension posts 138A, 138B and generate a spring force to control movement of the handle assembly 132 as the handle assembly 132 moves from the extended position 132B to the collapsed position 132A. In another example, referring to FIG. 15B, the first and/or second damper 360A, 360B may each include a magnet 384 configured to attract to a magnetic counterpart 385 (such as another magnet or ferromagnetic member) disposed in the first support channel 350A and the second support channel 350B, respectively, to control movement of the handle assembly 132 as the handle assembly 132 moves from the extended position 132B to the collapsed position 132A. While FIGS. 15A and 15B show only the first damper 360A, it should be appreciated that the second damper 360B may have the same or similar structure as described above. In other examples, the first and/or second damper 360A, 360B may each include a resilient ring supported in a channel and arranged to expand outwardly to frictionally-engage the support channels with a piston ring style configuration (not shown). Other configurations are contemplated.

Referring back to FIGS. 6A through 6C, the handle assembly 132 is configured for movement between the extended position 132B (shown in FIG. 6A) where the upper grip 136 is spaced from the user interface 204 at a first distance D1, and the collapsed position 132A (shown in FIG. 6C) where the upper grip 136 is disposed adjacent to the user interface 204. Additionally, the handle assembly 132 may be configured for movement to an intermediate position 132C (shown in FIG. 6B) where the upper grip 136 is spaced from the user interface 204 at a second distance D2, less than the first distance D1.

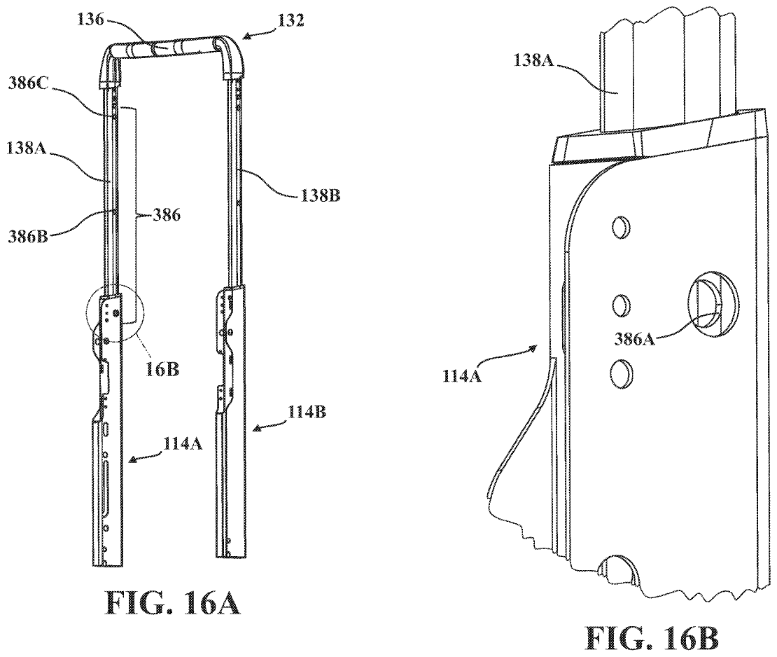

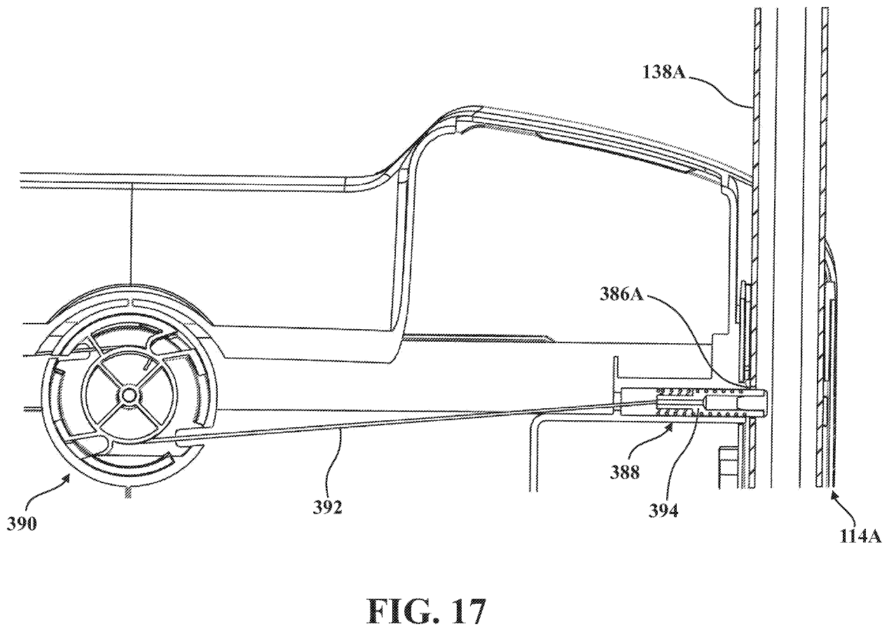

Referring to FIGS. 16A through 17, one of the first extension post 138A and the first support channel 350A may define a plurality of detents 386. The plurality of detents 386 may include a first detent 386A corresponding to the extended position 132B, a second detent 386B corresponding to the intermediate position 132C, and a third detent 386C corresponding to the collapsed position 132A. The other of the first extension post 138A and the first support channel 350A may include a detent mechanism 388 configured to engage the plurality of detents 386 to retain the handle assembly 132 in one of the collapsed position 132A (see FIG. 6A), extended position 132B (see FIG. 6C), and the intermediate position 132C (see FIG. 6B). Similarly, one of the second extension post 138B and the second support channel 350B may define the plurality of detents 386, and the other of the second extension post 138B and the second support channel 350B may include a detent mechanism 388 configured to engage the plurality of detents 386.

The detent mechanism 388 may be coupled to a detent release 390 arranged for engagement by the caregiver. As is best shown in FIGS. 8 and 17, the detent release 390 may be realized as a rotatable member arranged between the first and second rear uprights 114A, 114B. The detent release 390 may be operatively attached to a cable 392 connected to detent mechanism 388 that is configured to move a plunger 394 in and out of one of the plurality of detents 386 to maintain the handle assembly 132 in one of the collapsed position 132A, the intermediate position 132C, and the extended position 132B. Here, it will be appreciated that the detent mechanism 388 and/or the detent release 390 could be of a number of different styles, types, configurations, and the like sufficient to facilitate selectively locking the handle assembly 132 in a desired position. In some versions, the handle assembly 132, the detent mechanism 388 and/or the detent release 390 could be configured similar to as is disclosed in U.S. Pat. No. 6,648,343, previously incorporated by reference. Other configurations are contemplated.

Notably, the first and/or the second damper 360A, 360B, may be configured to slow translation of the first and/or second extension posts 138A, 138B as the handle assembly 132 moves from the extended position 132B toward the intermediate position 132C to promote engagement of detent mechanism 388 with the second detent 386B to retain the handle assembly 132 in the intermediate position 132C. For example, without the first and/or the second damper 360A, 360B, the handle assembly 132 may translate past the detent mechanism 388 too quickly such that the detent mechanism 388 is unable to engage the second detent 386B. Accordingly, the first and/or the second damper 360A, 360B slow translation of the handle assembly 132 to promote engagement of the handle assembly 132 with the detent mechanism 388 to retain the handle assembly 132 in a desired position.

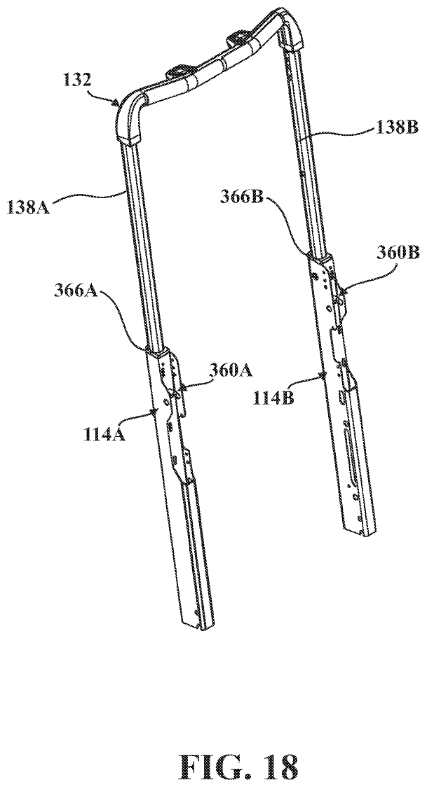

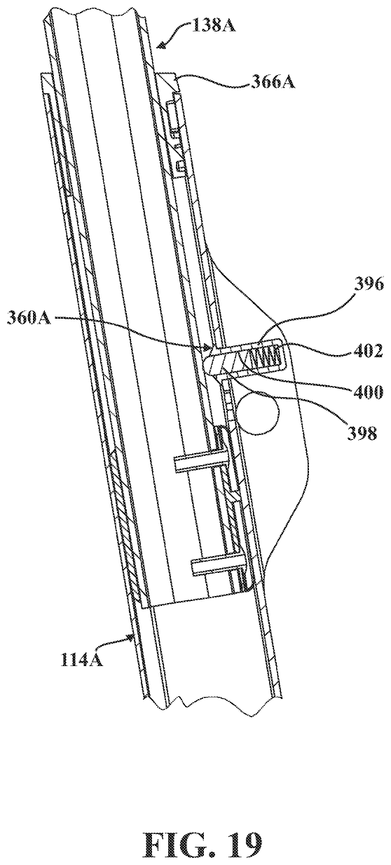

Referring now to FIGS. 18 through 19, in some versions, the damper 360A, 360B includes a damper body 396 operatively attached to one of the extension post 138A, 138B and the rear upright 114A, 114B, and a damper detent 398 arranged to abut the other of the extension post 138A, 138B and the rear upright 114A, 114B. The damper body 396 defines a damper channel 400, and the damper detent 398 is supported for movement along the damper channel 400. Here, the abutment of the damper detent 398 controls movement of the extension post 138A, 138B as the handle assembly 132 moves from the extended position 132A to the collapsed position 132B. This configuration also loads the extension post 138A, 138B against the bushings 366A, 366B. As is depicted in FIG. 19, in this version, the damper 360A, 360B also includes a damper biasing element 402 supported along the damper channel 400 and interposed between the damper body 396 and the damper detent 398 to urge the damper detent 398 away from the damper body 396 along the damper channel 400. In this version, the damper body 396 is operatively attached to the rear upright 114A, 114B, and the damper biasing element 402 is arranged to urge the damper detent 398 into abutment with the extension post 138A, 138B. However, it will be appreciated that other configurations are contemplated, and the damper body 396 could instead be operatively attached to the extension post 138A, 138B.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A patient transport apparatus operable by a user for transporting a patient along stairs, the patient transport apparatus comprising:
a support structure including a rear support assembly having a rear upright defining a support channel;
a seat section and a back section coupled to the support structure for supporting the patient;
a track assembly extending from the support structure and having a belt for traversing stairs;
a motor coupled to the track assembly to selectively generate torque to drive the belt; and
a user interface disposed on the rear support assembly and arranged for engagement by a user and including an activation input control for operating the motor to drive the belt; and
   a handle assembly including:
   an upper grip;
   an extension post supporting the upper grip and disposed in the support channel to guide movement of the handle assembly between:
      an extended position where the upper grip is spaced from the user interface, and
      a collapsed position where the upper grip is disposed adjacent to the user interface; and
   a damper interposed between the support channel and the extension post to control movement of the extension post as the handle assembly moves from the extended position to the collapsed position.

II. The patient transport apparatus of clause I, wherein the damper comprises a deflectable member operatively attached to one of the extension post and the support channel and configured to abut the other of the extension post and the support channel to control movement of the extension post as the handle assembly moves from the extended position to the collapsed position.
III. The patient transport apparatus of any of clauses I-II, wherein the handle assembly and the user interface define a pinch area when the handle assembly is in the collapsed position.
IV. The patient transport apparatus of clause III, wherein the damper is configured to slow translation of the extension post within the support channel as the handle assembly moves into the pinch area.
V. The patient transport apparatus of any of clauses I-IV, wherein the support structure further includes a bushing disposed in an upper upright end of the support channel, the bushing configured to slidably receive the extension post to guide movement of the extension post within the support channel.
VI. The patient transport apparatus of any of clauses I-V, wherein:
the extension post includes a collar to guide movement of the extension post within the support channel; and
the damper includes a deflectable member coupled to the collar and configured to abut the support channel to control movement of the extension post as the handle assembly moves from the extended position to the collapsed position.
VII. The patient transport apparatus of clause VI, wherein the deflectable member and the collar are integrally formed as a unitary component.
VIII. The patient transport apparatus of clause VII, wherein the deflectable member extends between a first end extending from the collar and a second end extending away from the extension post and arranged to abut the support channel to control movement of the extension post as the handle assembly moves from the extended position to the collapsed position.
IX. The patient transport apparatus of any of clauses VI-VIII, wherein the damper further comprises a fastener disposed through the deflectable member to couple the deflectable member to the collar.
X. The patient transport apparatus of clause IX, wherein:
   the deflectable member extends between a first end and a second end;
the fastener is disposed through the first end of the deflectable member to couple the first end of the deflectable member to the collar; and
the second end of the deflectable member is configured to abut the support channel to control movement of the extension post as the handle assembly moves from the extended position to the collapsed position.
XI. The patient transport apparatus of clause IX, wherein:

the deflectable member extends between a first end and a second end;
the fastener is defined as a first fastener disposed through the first end of the deflectable member to couple the first end of the deflectable member to the collar;
   the damper further includes a second fastener disposed through the second end of the deflectable member to couple the second end of the deflectable member to the collar; and
   the deflectable member defines an arch between the first end and the second end configured to abut the support channel to control movement of the extension post as the handle assembly moves from the extended position to the collapsed position.
XII. The patient transport apparatus of any of clauses IX-XI, wherein:
   the rear upright includes a front wall, a rear wall spaced from the front wall, a first lateral wall extending between the front wall and the rear wall, and a second lateral wall spaced from the first lateral wall and extending between the front wall and the rear wall; and
   the front wall, the rear wall, and the first and second lateral walls define the support channel.
XIII. The patient transport apparatus of clause XII, wherein the support channel defines a rounded rectangular profile.
XIV. The patient transport apparatus of clause XIII, wherein the extension post defines a rounded rectangular profile corresponding to the profile of the support channel.
XV. The patient transport apparatus of any of clauses XII-XIV, wherein:
the collar includes a first land and a second land spaced from the first land, the first and second lands arranged to abut one of the front wall and the rear wall to guide movement of the extension post within the support channel; and
the collar defines a collar channel between the first land and the second land, and the deflectable member is disposed in the collar channel.
XVI. The patient transport apparatus of any of clauses I-XV, wherein:
the upper grip is spaced from the user interface at a first distance when the handle assembly is in the extended position; and
the handle assembly is further configured for movement to an intermediate position where the upper grip is spaced from the user interface at a second distance, less than the first distance.
XVII. The patient transport apparatus of clause XVI, wherein:
   one of the extension post and the support channel defines a plurality of detents, the plurality of detents including:
   a first detent corresponding to the extended position, and
   a second detent corresponding to the intermediate position; and
   the other of the extension post and the support channel includes a detent mechanism configured to engage the plurality of detents to retain the handle assembly in one of the extended position and the intermediate position.
XVIII. The patient transport apparatus of clause XVII, wherein the plurality of detents further includes a third detent corresponding to the collapsed position, and the detent mechanism is configured to engage the plurality of detents to retain the handle assembly in one of the extended position, the intermediate position, and the collapsed position.
XIX. The patient transport apparatus of any of clauses XVII-XVIII, wherein the damper is configured to slow translation of the extension post within the support channel as the handle assembly moves from the extended position toward the intermediate position to promote engagement of detent mechanism with the second detent to retain the handle assembly in the intermediate position.
XX. The patient transport apparatus of any of clauses I-XIX, wherein:
the rear upright is further defined as a first rear upright arranged on a first side of the rear support assembly, and the support channel is further defined as a first support channel defined by the first rear upright; and
the rear support assembly further includes a second rear upright arranged on a second side of the rear support assembly, opposite the first side, the second rear upright defining a second support channel.
XXI. The patient transport apparatus of clause XX, wherein:
   the upper grip extends between a first grip end and a second grip end; and
   the extension post is further defined as a first extension post operatively attached to the first grip end and disposed in the first support channel; and
   the handle assembly further includes a second extension post operatively attached to the second grip end and disposed in the second support channel.
XXII. The patient transport apparatus of clause XXI, wherein:
   the damper is further defined as a first damper interposed between the first support channel and the first extension post to control movement of the first extension post as the handle assembly moves from the extended position to the collapsed position; and
the patient transport apparatus further comprises a second damper interposed between the second support channel and the second extension post to control movement of the second extension post as the handle assembly moves from the extended position to the collapsed position.
XXIII. The patient transport apparatus of clause XXII, wherein the handle assembly and the user interface define a pinch area when the handle assembly is in the collapsed position.
XXIV. The patient transport apparatus of clause XXIII, wherein:
the first damper is configured to slow translation of the first extension post within the first support channel as the handle assembly moves into the pinch area; and
the second damper is configured to slow translation of the second extension post within the second support channel as the handle assembly moves into the pinch area.
XXV. The patient transport apparatus of clauses XXII-XXIV, wherein the first damper comprises a first deflectable member operatively attached to one of the first extension post and the first support channel, the first deflectable member configured to abut the other of the first extension post and the first support channel to control movement of the first extension post as the handle assembly moves from the extended position to the collapsed position.
XXVI. The patient transport apparatus of any of clauses XXII-XXV, wherein:
the first extension post includes a first collar to guide movement of the first extension post within the first support channel; and
the first damper includes a first deflectable member coupled to the first collar, the first deflectable member configured to abut the first support channel to control movement of the first extension post as the handle assembly moves from the extended position to the collapsed position.
XXVII. The patient transport apparatus of any of clauses XXII-XXVI, wherein the second damper comprises a second deflectable member operatively attached to one of the second extension post and the second support channel, the second deflectable member configured to abut the other of the second extension post and the second support channel to control movement of the second extension post as the handle assembly moves from the extended position to the collapsed position.
XXVIII. The patient transport apparatus of any of clauses XXII-XXVII, wherein:
the second extension post includes a second collar to guide movement of the second extension post within the second support channel; and
the second damper includes a second deflectable member coupled to the second collar, the second deflectable member configured to abut the second support channel to control movement of the second extension post as the handle assembly moves from the extended position to the collapsed position.
XXIX. The patient transport apparatus of any of clauses I-XXVIII, wherein the damper is operatively attached to the rear upright.
XXX. The patient transport apparatus of any of clauses I-XXIX, wherein the damper includes:
a damper body operatively attached to one of the extension post and the rear upright, the damper body defining a damper channel; and
a damper detent supported for movement along the damper channel and configured to abut the other of the extension post and the rear upright to control movement of the extension post as the handle assembly moves from the extended position to the collapsed position.
XXXI. The patient transport apparatus of clause XXX, wherein the damper further includes a damper biasing element supported along the damper channel to urge the damper detent away from the damper body along the damper channel.
XXXII. The patient transport apparatus of clause XXXI, wherein the damper body is operatively attached to the rear upright; and
wherein the damper biasing element is arranged to urge the damper detent into abutment with the extension post.

1. A patient transport apparatus operable by a user for transporting a patient along stairs, the patient transport apparatus comprising:
a support structure including a rear support assembly having a rear upright defining a support channel;
a seat section and a back section coupled to the support structure for supporting the patient;
a track assembly extending from the support structure and having a belt for traversing stairs;
a motor coupled to the track assembly to selectively generate torque to drive the belt; and
a user interface disposed on the rear support assembly and arranged for engagement by a user and including an activation input control for operating the motor to drive the belt; and
a handle assembly including:
an upper grip;
an extension post supporting the upper grip and disposed in the support channel to guide movement of the handle assembly between:
an extended position where the upper grip is spaced from the user interface, and
a collapsed position where the upper grip is disposed adjacent to the user interface; and
a damper interposed between the support channel and the extension post to control movement of the extension post as the handle assembly moves from the extended position to the collapsed position.

2. The patient transport apparatus of claim 1, wherein the damper comprises a deflectable member operatively attached to one of the extension post and the support channel and configured to abut the other of the extension post and the support channel to control movement of the extension post as the handle assembly moves from the extended position to the collapsed position.

3. The patient transport apparatus of claim 1, wherein the handle assembly and the user interface define a pinch area when the handle assembly is in the collapsed position.

4. The patient transport apparatus of claim 3, wherein the damper is configured to slow translation of the extension post within the support channel as the handle assembly moves into the pinch area.

5. The patient transport apparatus of claim 1, wherein the support structure further includes a bushing disposed in an upper upright end of the support channel, the bushing configured to slidably receive the extension post to guide movement of the extension post within the support channel.

6. The patient transport apparatus of claim 1, wherein:
the extension post includes a collar to guide movement of the extension post within the support channel; and
the damper includes a deflectable member coupled to the collar and configured to abut the support channel to control movement of the extension post as the handle assembly moves from the extended position to the collapsed position.

7. (canceled)

8. (canceled)

9. The patient transport apparatus of claim 6, wherein the damper further comprises a fastener disposed through the deflectable member to couple the deflectable member to the collar.

10. The patient transport apparatus of claim 9, wherein:
the deflectable member extends between a first end and a second end;
the fastener is disposed through the first end of the deflectable member to couple the first end of the deflectable member to the collar; and
the second end of the deflectable member is configured to abut the support channel to control movement of the extension post as the handle assembly moves from the extended position to the collapsed position.

11. The patient transport apparatus of claim 9, wherein:
the deflectable member extends between a first end and a second end;
the fastener is defined as a first fastener disposed through the first end of the deflectable member to couple the first end of the deflectable member to the collar;
the damper further includes a second fastener disposed through the second end of the deflectable member to couple the second end of the deflectable member to the collar; and
the deflectable member defines an arch between the first end and the second end configured to abut the support channel to control movement of the extension post as the handle assembly moves from the extended position to the collapsed position.

12. The patient transport apparatus of claim 6, wherein:
the rear upright includes a front wall, a rear wall spaced from the front wall, a first lateral wall extending between the front wall and the rear wall, and a second lateral wall spaced from the first lateral wall and extending between the front wall and the rear wall; and
the front wall, the rear wall, and the first and second lateral walls define the support channel.

13. The patient transport apparatus of claim 12, wherein the support channel defines a rounded rectangular profile.

14. The patient transport apparatus of claim 13, wherein the extension post defines a rounded rectangular profile corresponding to the profile of the support channel.

15. The patient transport apparatus of claim 12, wherein:
the collar includes a first land and a second land spaced from the first land, the first and second lands arranged to abut one of the front wall and the rear wall to guide movement of the extension post within the support channel; and
the collar defines a collar channel between the first land and the second land, and the deflectable member is disposed in the collar channel.

16. The patient transport apparatus of claim 1, wherein:
the upper grip is spaced from the user interface at a first distance when the handle assembly is in the extended position; and
the handle assembly is further configured for movement to an intermediate position where the upper grip is spaced from the user interface at a second distance, less than the first distance.

17. The patient transport apparatus of claim 16, wherein:
one of the extension post and the support channel defines a plurality of detents, the plurality of detents including:
a first detent corresponding to the extended position, and
a second detent corresponding to the intermediate position; and
the other of the extension post and the support channel includes a detent mechanism configured to engage the plurality of detents to retain the handle assembly in one of the extended position and the intermediate position.

18. The patient transport apparatus of claim 17, wherein the plurality of detents further includes a third detent corresponding to the collapsed position, and the detent mechanism is configured to engage the plurality of detents to retain the handle assembly in one of the extended position, the intermediate position, and the collapsed position.

19. The patient transport apparatus of claim 17, wherein the damper is configured to slow translation of the extension post within the support channel as the handle assembly moves from the extended position toward the intermediate position to promote engagement of detent mechanism with the second detent to retain the handle assembly in the intermediate position.

20. (canceled)

21. (canceled)

22. (canceled)

23. (canceled)

24. (canceled)

25. (canceled)

26. (canceled)

27. (canceled)

28. (canceled)

29. (canceled)

30. The patient transport apparatus of claim 1, wherein the damper includes:
a damper body operatively attached to one of the extension post and the rear upright, the damper body defining a damper channel; and
a damper detent supported for movement along the damper channel and configured to abut the other of the extension post and the rear upright to control movement of the extension post as the handle assembly moves from the extended position to the collapsed position.

31. The patient transport apparatus of claim 30, wherein the damper further includes a damper biasing element supported along the damper channel to urge the damper detent away from the damper body along the damper channel.

32. The patient transport apparatus of claim 31, wherein the damper body is operatively attached to the rear upright; and
wherein the damper biasing element is arranged to urge the damper detent into abutment with the extension post.
